(19) United States
(12) Patent Application Publication
(10) Pub. No.: US 2026/0222163 A1
(43) Pub. Date: Jul. 30, 2026

(54) METHODS FOR ACCURATE CSI PREDICTION IN WIRELESS SYSTEMS

(71) Applicant: INTERDIGITAL PATENT HOLDINGS, INC., Wilmington, DE (US)

(72) Inventors: Ibrahim Hemadeh, Hemel Hempstead (GB); Ahmet Serdar Tan, London (GB); Arman Shojaeifard, London (GB); Mihaela Beluri, Jericho, NY (US); Patrick Tooher, Montreal (CA); Mohamed Amine Arfaoui, Montreal (CA); yugeswar Deenoo Narayanan Thangaraj, Chalfont, PA (US); Moon IL Lee, Melville, NY (US)

(73) Assignee: INTERDIGITAL PATENT HOLDINGS, INC., Wilmington, DE (US)

(21) Appl. No.: 19/148,141

(22) PCT Filed: Feb. 2, 2024
(86) PCT No.: PCT/US2024/014312

§ 371 Date: Jul. 15, 2025

Related U.S. Application Data
(60) Provisional application No. 63/443,219, filed on Feb. 3, 2023.

(51) Int. Cl. H04L 5/00; H04W 24/10; H04W 72/542

(52) U.S. Cl. CPC H04L 5/0094; H04L 5/0057; H04W 24/10; H04W 72/542

(57) ABSTRACT

A WTRU receives, configuration information including: a set of reference signals (RSs) for channel state information (CSI) prediction; one or more CSI prediction parameters including a set of lengths (L) and resources of one or more prediction windows; one or more prediction accuracy thresholds; and one or more sets of resources for CSI reporting. The WTRU receives and measures RSs associated with the configured set of RSs and determines predicted CSI values for resources of one or more configured prediction windows and determines preferred CSI prediction parameters as a function of measurements of the received RSs and configured prediction accuracy threshold(s). The WTRU reports, to the base station, using the configured one or more sets of resources for CSI reporting, the determined preferred CSI prediction parameters and the determined predicted CSI values for one or more subsequent prediction windows. Additional embodiments are disclosed.

### CROSS-REFERENCE TO RELATED APPLICATIONS

This application claims the benefit of U.S. Provisional Application No. 63/443,219, filed Feb. 3, 2023, the contents of which are incorporated in its entirety herein by reference.

### BACKGROUND

Channel State Information (CSI) is used in wireless systems to provide feedback regarding conditions of connectivity. In some environments, CSI may include at least one of the following: channel quality index (CQI), rank indicator (RI), precoding matrix index (PMI), Layer-1 channel measurements and/or any other measurement quantity are determined by a wireless transmit receive unit (WTRU) based on configured reference signals (RSs). In multiple-input-multiple-output (MIMO) systems, as the number of antenna ports increases, the overhead for transmitting and providing feedback on CSI also increases in both the uplink and downlink. This increase in overhead invites practical challenges in obtaining and maintaining accurate CSI, that rely on reference signals sent to the WTRU for measurement and subsequent reporting to a network access station. As the number of antennas is expected to continue increasing in next generation systems, this overhead is also expected to grow. Artificial intelligence machine learning (AIML) may be used to predict CSI using models based on previous measurements of reference signals. Accurate CSI reporting is critical to ensure optimal system performance (including beamforming, scheduling and link adaptation). For systems using CSI prediction, it is important to determine the prediction accuracy. Methods and devices for monitoring and reporting the CSI prediction accuracy as well as reducing the CSI feedback overhead when reporting predicted CSI are needed.

### SUMMARY

According to certain aspects, CSI prediction techniques are disclosed for reducing CSI overhead in the DL and UL. In one aspect a user equipment (UE), also referred to herein as a WTRU, is configured to perform prediction for CSI feedback and determining and reporting preferred components for CSI prediction as a function of channel conditions and configured prediction accuracy criteria.

Methods are also disclosed for a WTRU performing CSI prediction, to determine and report the accuracy of the predicted CSI. Further aspects are disclosed for a WTRU performing CSI prediction by the WTRU determining a subset of CSI components to report (i.e. reduced CSI report), as a function of the change (or frequency of change) in the predicted component and the component prediction accuracy.

For WTRU-side CSI prediction, data collection is based on measurements of CSI-RS(s), possibly over a period of time. CSI prediction can be defined to operate on two time windows; a first window during which the WTRU accumulates measurements to use for inference of predicted CSI, and a second window for which the predicted CSI is applicable.

Certain benefits of CSI prediction may be a reduction of CSI-RS(s) and CSI reporting overhead. The window durations impact the CSI-RS configuration (i.e., CSI-RS need to be transmitted at least during the first window) and CSI reporting configuration (i.e., the sizes of the windows impact the timing and size of CSI reports). Furthermore, appropriate window durations are impacted by the prediction performance (e.g., of an AI/ML model), which in turn may be impacted by channel conditions. Therefore configurable window durations are desirable to enable efficient WTRU-side CSI predictions, regardless of whether AI/ML is used for WTRU-side CSI prediction.

The window durations can be controlled by the gNB. However, their configurations depend on WTRU feedback. Time domain channel property (TDCP) feedback is currently being specified in 3GPP Rel-18 and can be used by the gNB to determine appropriate window size. Additional WTRU feedback, for example based on AI/ML prediction performance under specific channel conditions, is important for accurate CSI prediction.

Metrics for monitoring the WTRU-side CSI prediction model that are more indicative of end-to-end performance are disclosed. In one example, a gNB can also monitor/estimate the performance of WTRU-side CSI prediction model through other means including hybrid automatic repeat request (HARQ) feedback from the WTRU and other measurement reporting. For example, if a gNB receives consecutive negative acknowledgments (NACKs) from the scheduling based on predicted CSI, the gNB may consider that the CSI prediction at the WTRU is not performing well and configure to fall back to legacy CSI reporting. Also, a gNB may periodically trigger a CSI reporting for a specific time occasion and compare between predicted CSI and measured CSI. In this case, monitoring of the CSI prediction model performance can be performed at the gNB side and it will be specification transparent as higher layer configure/re-configure between legacy CSI reporting mode and CSI prediction mode, or use both the same time. As used herein, “legacy CSI reporting” means CSI reporting without prediction or AIML models.

According to one aspect, methods and devices for improving CSI measurement and feedback are disclosed in which CSI prediction, i.e., based on artificial intelligence machine learning (AIML), may be utilized to reduce CSI overhead and reduce a number of transmit occasions. According to another aspect, one or more methods are disclosed to assess and indicate the accuracy of AIML prediction in order to request and achieve reduced CSI-reference signal (RS) transmissions. Further aspects are disclosed that relate to methods for reporting the accuracy of CSI prediction in order to monitor and supervise CSI prediction operations. Additional aspects may relate to methods and devices configured to exploit the accuracy of CSI prediction as well as varying each CSI component, or a set of components, to obtain a reduced CSI feedback without impacting quality of CSI feedback and utilization.

In one specific example, a method for a wireless transmit receive unit (WTRU) includes receiving, from a base station, configuration information including: a first set of reference signals (RSs) for channel state information (CSI) prediction; one or more CSI prediction parameters including a set of lengths (L) and resources of one or more prediction windows; one or more prediction accuracy thresholds; and one or more sets of resources for CSI reporting. The WTRU receives, from the base station, one or more RSs associated with the first set of RSs and determines predicted CSI values for resources of at least one of the one or more configured prediction windows. The WTRU determines preferred CSI prediction parameters, preferably as a function of RS measurements and configured prediction accuracy threshold(s), and reports, to the base station, using the configured one or more sets of resources for CSI reporting, the determined preferred CSI prediction parameters and the determined predicted CSI values for one or more subsequent prediction windows.

According to certain aspects, predicted CSI values relate to any of a rank indicator (RI), channel quality index (CQI), precoding matrix indicator (PMI), layer indicator (LI), CSI-RS resource indicator (CRI), signal interference-to-noise ratio (SINR), reference signal received power (RSRP), reference signal received quality (RSRQ), received signal strength indicator (RSSI), doppler spread, angle of arrival (AoA), angle of departure (AoD), delay spread or average delay. In some embodiments, preferred CSI prediction parameters include one or more of a length (L) of a prediction window and/or a number (K) of CSI-RS resources desired for a prediction window.

In one embodiment, a second set of RSs may be included in the WTRU configuration information and used to validate or adjust predicted CSI and/or preferred CSI prediction parameters by receiving, from the base station, one or more RSs associated with the second set of RSs and validating or adjusting the determined preferred CSI prediction parameters. The WTRU reports CSI validation or adjustment information to the base station based on measurements of the received one or more RSs associated with the second set of RSs.

According to one aspect, the determined preferred CSI prediction parameters are validated when measurements of the one or more RSs associated with the second set of RS meet or exceed an accuracy criterion. In one embodiment, the WTRU requests a reduced number of RSs for the one or more subsequent prediction windows when the accuracy criterion is exceeded by a predetermined amount or requests an increased number of RSs for the one or more subsequent prediction windows when the accuracy criterion is exceeded by less than the predetermined amount.

In certain embodiments, the WTRU configuration information includes a third set of RSs and, prior to receiving the one or more RSs associated with the first set of RSs, the WTRU receives, from the base station, one or more RSs associated with the third set of RSs. The WTRU may use measurements of RSs associated with the third set to train an artificial intelligence machine learning (AIML) model for CSI prediction while the WTRU performs legacy CSI reporting. Additional features and aspects are further disclosed

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of a configuration for CSI reporting settings, resource settings, and link;

FIG. 3 shows a basic concept of codebook-based precoding with feedback information;

FIG. 4 shows an example recurrent neural network (RNN) architecture;

FIG. 5 illustrates an example CSI prediction procedure according to one example embodiment;

FIG. 6 is a timing diagram showing a WTRU process of reporting CSI with look ahead windows and adjustment of reference signals (RSs) according to one example embodiment;

FIG. 7 shows a timing diagram of a process of reporting and configuration of CSI prediction parameters of an example embodiment;

FIG. 8 shows an example signal flow between a base station and WTRU for CSI prediction according to certain embodiments;

FIG. 9 illustrates an example signal flow when CSI prediction accuracy is greater than a configured threshold in one example;

FIG. 10 shows an example signal flow when CSI prediction accuracy is lower than a configured threshold in one example;

FIG. 11 is an example representation of varying grades of CSI prediction accuracy during multiple windows;

FIG. 12 is an example illustrates an example of K adaptation as a function of the gradient of prediction accuracy along multiple windows;

FIG. 13 shows an accuracy verses time example of graded CSI prediction accuracy over multiple windows;

FIG. 14 is a flow diagram showing an example method for determining a number of CSI-RS transmissions during a next look-ahead window based on per component accuracy reporting;

FIG. 15 illustrates an example signal flow for per component accuracy reporting according to one example embodiment;

FIG. 16 shows an example of variation of a CSI component over multiple windows;

FIG. 17 is a flow diagram illustrating a method of CSI prediction and reporting according to one example embodiment;

FIG. 18 is a flow diagram illustrating a method for a WTRU performing CSI prediction according to one example embodiment;

FIG. 19 is a flow diagram illustrating a method of CSI prediction accuracy reporting according to an embodiment; and

FIG. 20 is a flow diagram illustrating a method of CSI prediction and reporting of accuracy of CSI components according to an embodiment.

### DETAILED DESCRIPTION

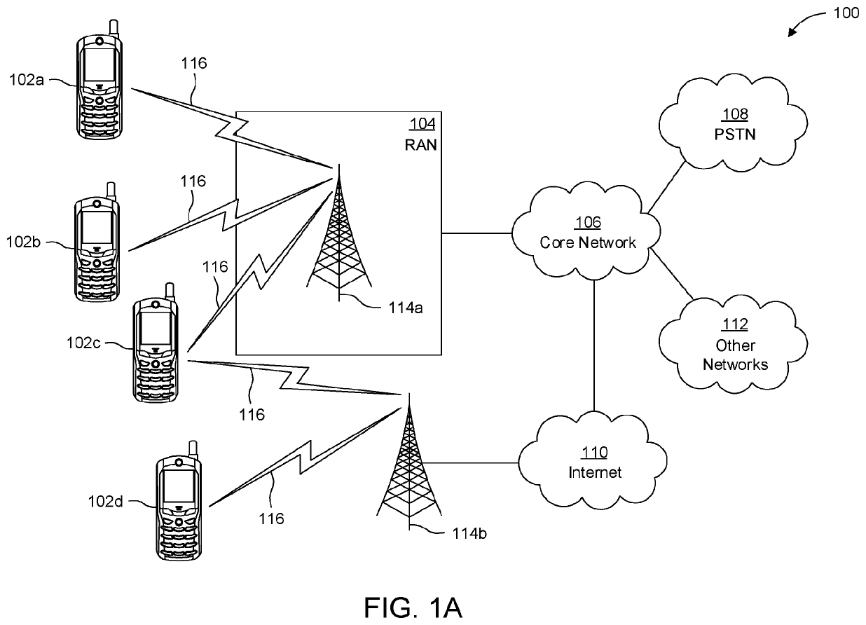

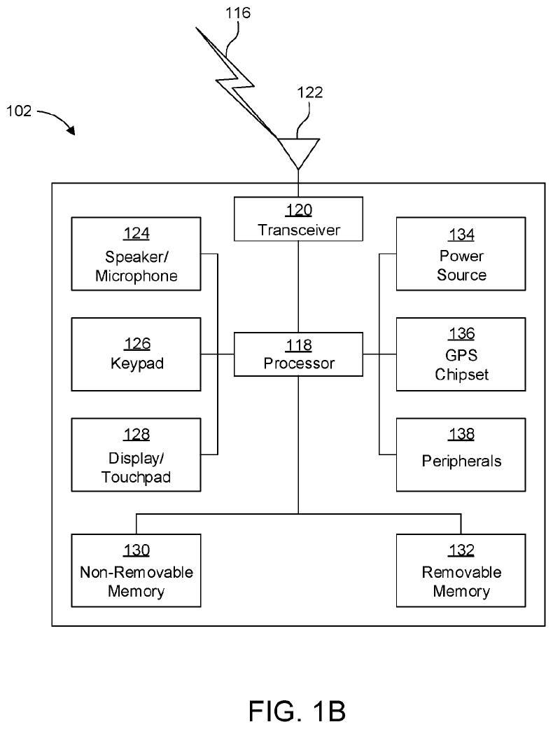

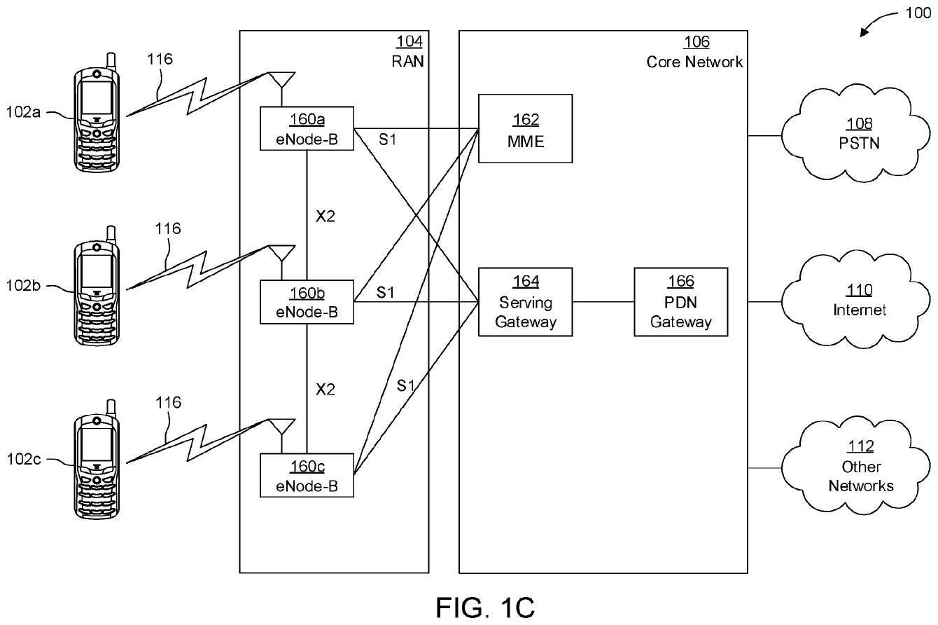

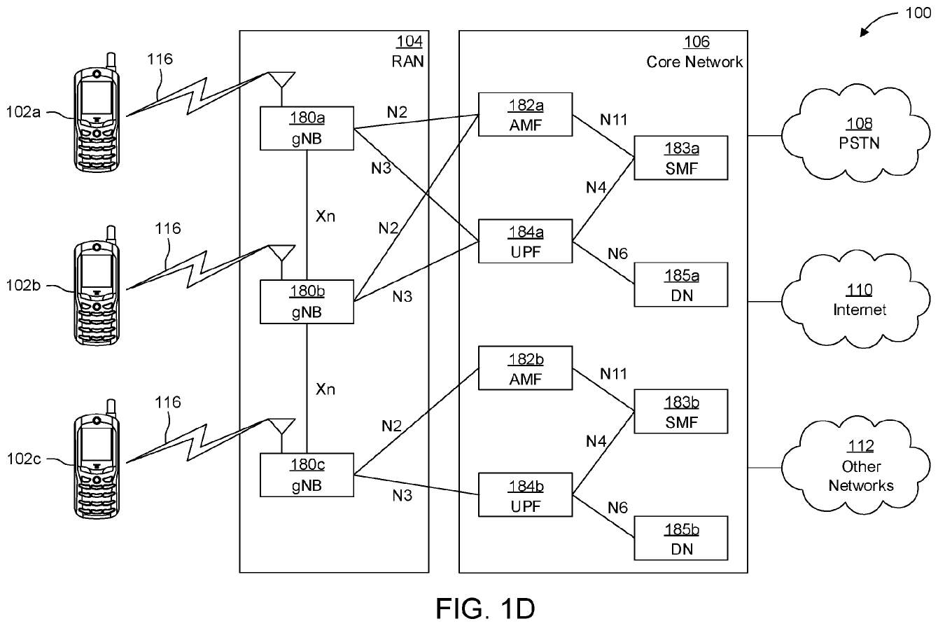

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As mentioned previously, Channel State Information (CSI), may include at least one of the following: channel quality index (CQI), rank indicator (RI), precoding matrix index (PMI), an L1 channel measurement (e.g., reference signal received power (RSRP) such as L1-RSRP, or signal interference-to-noise ratio (SINR)), CSI-RS resource indicator (CRI), synchronization signal/physical broadcast channel (SS/PBCH) block resource indicator (SSBRI), layer indicator (LI) and/or any other measurement quantity measured by the WTRU from the configured reference signals (RSs) (e.g. CSI-RS or SS/PBCH block or any other reference signal).

CSI reporting framework: A WTRU may be configured to report the CSI through the physical uplink control channel (PUCCH), or per the gNBs' request on an UL physical uplink shared channel (PUSCH) grant. Depending on the configuration, CSI-RS can cover the full bandwidth of a bandwidth part (BWP) or just a fraction of it. Within the CSI-RS bandwidth, CSI-RSs can be configured in each physical resource block (PRB) or every other PRB. In the time domain, CSI-RS resources can be configured either periodic, semi-persistent, or aperiodic.

Semi-persistent CSI-RS is similar to periodic CSI-RS, except that the resource can be (de)-activated by medium access control (MAC) control elements (CEs) and the WTRU reports related measurements only when the resource is activated. For Aperiodic CSI-RS, the WTRU is triggered to report measured CSI-RS(s) on the PUSCH, by request in a downlink control information (DCI). Periodic reports are carried over the PUCCH, while semi-persistent reports can be carried either on the PUCCH or PUSCH.

The reported CSI may be used by the scheduler when allocating optimal resource blocks, possibly based on channel's time-frequency selectivity, in determining precoding matrices, beams, transmission mode and selecting suitable modulation and coding schemes (MCSs). The reliability, accuracy, and timeliness of WTRU CSI reports may be critical to meeting ultra-reliable low latency communications (URLLC) and/or other service requirements.

A WTRU may be configured with a CSI measurement setting which may include one or more CSI reporting settings, resource settings, and/or a link between one or more CSI reporting settings and one or more resource settings.

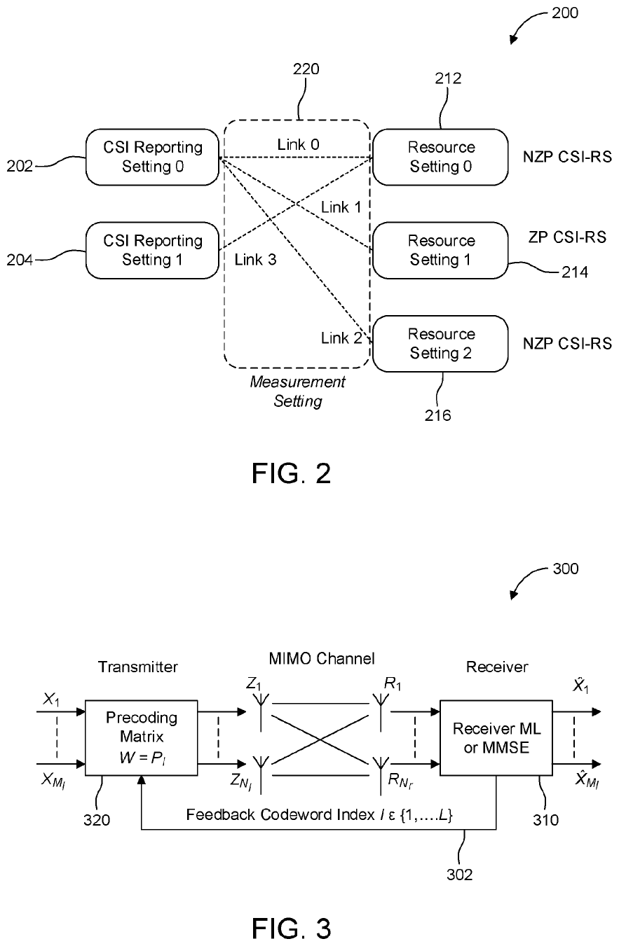

FIG. 2 shows an example of a configuration 200 for CSI reporting settings, resource settings, and links.

In a CSI measurement setting, one or more of the following configuration parameters may be provided:

(1) N≥1 CSI reporting settings 202, 204, M≥1 resource settings 212, 214, 216, and a CSI measurement setting 220 which links the N CSI reporting settings 202, 204 with the M resource settings 212, 214 and 216.

(2) A CSI reporting setting 202, 204 includes at least one of the following: (i) Time-domain behavior: e.g., aperiodic or periodic/semi-persistent; (ii) Frequency-granularity: at least for PMI and CQI; (iii) CSI reporting type (e.g., PMI, CQI, RI, CRI, etc.); and/or (iv) If a PMI is reported, the PMI Type (e.g., Type I or II) and codebook configuration.

(3) A Resource setting 212, 214, 216 includes at least one of the following: (i) Time-domain behavior: aperiodic or periodic/semi-persistent; (ii) RS type (e.g., for channel measurement or interference measurement); and (iii) S≥1 resource set(s) and each resource set can contain Ks resources.

(4) A CSI measurement setting 220 includes at least one of the following: (i) one CSI reporting setting; (ii) one resource setting; and/or (iii) for CQI, a reference transmission scheme setting.

(5) For CSI reporting for a component carrier, one or more of the following frequency granularities may be supported including Wideband CSI, Partial band CSI and Sub band CSI.

FIG. 3 shows a basic example 300 of codebook-based precoding with feedback information 302. The feedback information 302 may include a precoding matrix index (PMI), which may be referred to as a codeword index in the codebook example 300 of FIG. 3.

As shown in FIG. 3, a codebook may include a set of precoding vectors/matrices for each rank and the number of antenna ports, and each precoding vectors/matrices has its own index so that a receiver 310 may inform, via feedback 302, preferred precoding vector/matrix index(s) to a transmitter 320.

The codebook-based precoding may have performance degradation due to its finite number of precoding vector/matrix, as compared with non-codebook-based precoding. However, a major advantage of a codebook-based precoding may be lower control signaling/feedback overhead. Table 1 below shows an example of a codebook for two transmit (Tx) antennas.

TABLE 1
2Tx downlink codebook

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

CSI processing criteria: A CSI processing unit (CPU) may be referred to as a minimum CSI processing unit and a WTRU may support one or more CPUs (e.g., N CPUs). A WTRU with N CPUs may estimate N CSI feedbacks calculation in parallel, wherein N may be a WTRU capability. If a WTRU is requested to estimate more than N CSI feedbacks at the same time, the WTRU may only perform high priority N CSI feedbacks and the rest may be not estimated.

The start and end of each CPU processing may be determined based on the CSI report type (e.g., aperiodic, periodic, semi-persistent) as in the following examples:

For aperiodic CSI report, a CPU starts to be occupied from the first OFDM symbol after the physical downlink control channel (PDCCH) trigger until the last OFDM symbol of the PUSCH carrying the CSI report. For periodic and semi-persistent CSI reports, a CPU starts to be occupied from the first OFDM symbol of one or more associated measurement resources (no earlier than CSI reference resource), until the last OFDM symbol of the CSI report.

The number of CPUs occupied may be different based on the CSI measurement types (e.g., beam-based or non-beam based). For non-beam related reports, Ks CPUs, when Ks CSI-RS resources in the CSI-RS resource set for channel measurement. For beam-related reports (e.g., “cri-RSRP”, “ssb-Index-RSRP”, or “none”), 1-CPU irrespective of the number of CSI-RS resources in the CSI-RS resource set for channel measurement due to the CSI computation complexity being low. “None” is used for P3 operation or aperiodic tracking reference signal (TRS) transmission.

For an aperiodic CSI reporting with a single CSI-RS resource, 1-CPU is occupied. For a CSI reporting Ks CSI-RS resources, Ks CPUs are occupied, as the WTRU needs to perform CSI measurement for each CSI-RS resource. When the number of unoccupied CPUs (N_u) is less than the required CPUs (N_r) for CSI reporting: (i) The WTRU may drop N_r-N_u CSI reporting based on priorities in the case of uplink control information (UCI) on the PUSCH without data/HARQ; and/or (ii) the WTRU may report dummy information in Nr-Nu CSI reporting based on priorities in other cases to avoid rate-matching handling of PUSCH.

Artificial intelligence (AI) may be broadly defined as the behavior exhibited by machines. Such behavior may, for example, mimic cognitive functions to sense, reason, adapt and act. Machine learning (ML) may refer to type of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning refers to class of machine learning algorithms that employ artificial neural networks (specifically DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

AI/ML-based CSI Prediction. Recurrent neural networks (RNN) are proposed for AI/ML based CSI prediction, due to their strong time series prediction capabilities. RNNs are neural networks consisting of an input layer, an output layer and one (or more) hidden layers, where the hidden layers leverage memory of previous states to predict future samples.

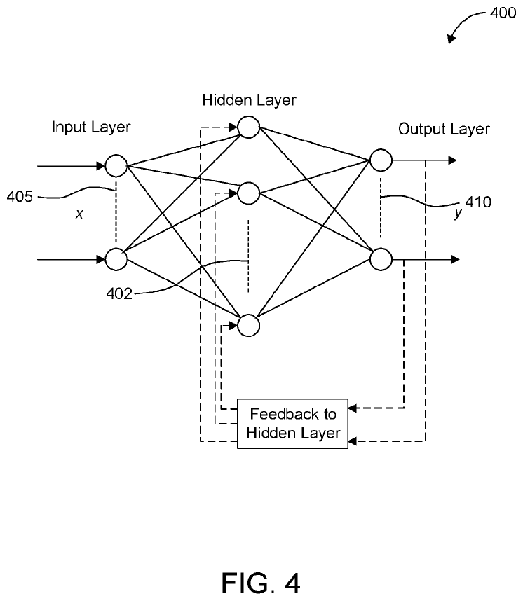

FIG. 4 shows one example RNN architecture 400, where the vector of hidden states 402 is a function of current inputs 405 and previous RNN output 410, where x(t) represents the vector at the RNN input 405 at time t, and y(t) represents the vector at RNN output 410 at time t. When the RNN is used for channel/CSI prediction, the input x consists of a sequence of N previous consecutive channel estimates according to Equation 1 below:

$$\tilde{H} ( t ) , \tilde{H} ( t - 1 ) , … \tilde{H} ( t - N + 1 ) \qquad Equation 1$$

To generate the RNN input, the estimated channel/CSI is fed to a tapped delay line. Moreover, depending on the RNN architecture, the input sequence of N channel estimates may be converted from matrix to vector form. The RNN output represents the predicted channel/CSI at time t+L, Ĥ(t+L).

An example of loss function used to train the RNN is determined by Equation 2 below:

$$ℒ = {‖ \hat{H} ( t + L ) - H ( C + L ) ‖}_{F}^{2} , \qquad Equation 2$$

where Ĥ(t+L) represents the predicted channel at time t+L, and H(t+L) represents the desired output of the network (the actual channel at time t+L) and the operator ∥ ∥_{F} indicates the Frobenius (Euclidean) norm. The loss function thus defined is used to train the RNN.

One approach for reducing the CSI overhead is to use the correlation characteristics of the channel in the spatial, frequency and angular domains. For example, a scalable and flexible CSI codebook with up to 32 ports may be used. The Type II codebook utilizes certain discrete Fourier transform (DFT) vectors to compress the spatial and frequency domains of the channel. A similar approach may be used for improving the frequency domain granularity. CSI feedback overhead may further be reduced through the exploitation of reciprocity in frequency division duplexing (FDD) operations. One of the use cases in recent efforts is the application of CSI prediction for CSI feedback enhancement.

As previously mentioned, in MIMO, as the number of antenna ports increases, the overhead for transmitting and providing feedback on CSI also increases in both the uplink and downlink. This increase in overhead induces practical challenges towards obtaining accurate CSI, as it relies on reference signals sent to the WTRU for measurement and subsequent reporting to the gNB. As the number of antennas is expected to continue increasing in future standards, this overhead is also expected to grow correspondingly. As disclosed herein accurate CSI may be achieved with reduced overhead based one or more of the following:
Embodiments for WTRU performing CSI prediction and reduce the CSI overhead by reducing the number of transmit occasions, or to improve CSI accuracy;
Embodiments for WTRU assessing and indicating the accuracy of prediction in order to request and achieve reduced CSI-RS transmissions where applicable;
Embodiments for reporting the accuracy of CSI prediction and to monitor and supervise the CSI prediction operation; and
Embodiments to exploit the accuracy of prediction and the variation of each CSI component, or a set of components, to obtain a reduced CSI feedback.

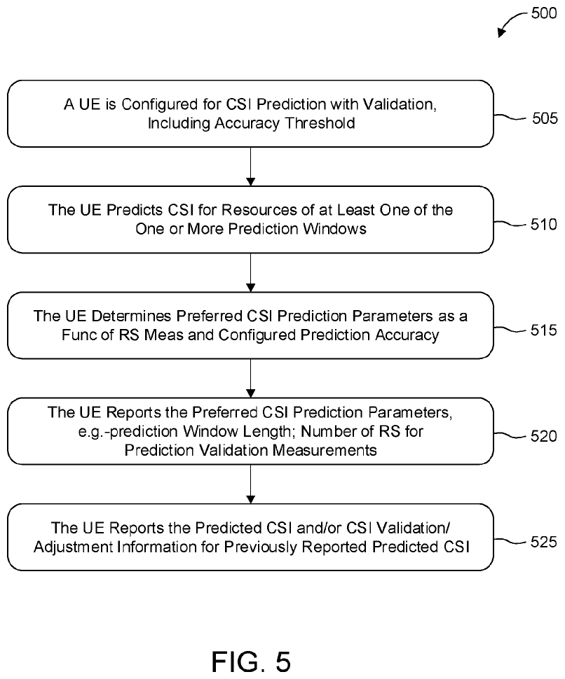

Example procedures for CSI Prediction will now be described. Referring to FIG. 5, an example method 500 for a WTRU performing CSI prediction and validation is shown. In one embodiment, a WTRU is configured 505 for CSI Prediction with validation. In this example, the WTRU configuration may include configuring at least one of: (i) one or more sets of reference signals input to a CSI predictor, where a first set may be used for training the CSI predictor model, a second set may be used for CSI prediction, and/or a third set may be used for validating the predicted CSI; (ii) a set of lengths (L) and resources of one or more prediction (e.g., look ahead) windows; (iii) prediction accuracy threshold(s); and/or (iv) one or more sets of resources for CSI reporting.

The WTRU performs measurements on received RS (e.g. configured from the second set of reference signals) and determines 510 predicted CSI for resources of at least one of the one or more prediction windows. The WTRU may also determine 515 preferred CSI prediction parameters, preferably as a function of RS measurements and configured prediction accuracy. In one example, the preferred CSI prediction parameters may include: one or more prediction window lengths (L); and one or more number of RS resources for prediction validation measurements (e.g., from the third set (K) used for validation of predicted CSI in a subsequent look-ahead windows).

Next, the WTRU reports 520 to the gNB the determined preferred CSI prediction parameters. The WTRU also reports 525 the predicted CSI. The report may include predicted CSI values for one (or more) subsequent prediction windows, and/or CSI validation/adjustment information for previously reported predicted CSI. Detailed examples are further discussed below.

In one embodiment, a WTRU performing CSI prediction is configured to monitor and report the CSI prediction accuracy (e.g. to enable adaptation of the CSI prediction parameters). A configuration for monitoring and reporting CSI prediction accuracy may include: (i) a type of accuracy monitored (e.g., current or temporal behavior); (ii) a minimum accuracy threshold, or set of accuracy values (e.g., above the minimum threshold); (iii) one or more prediction window resources; and/or (iv) one or more sets of reference signals (RS), K, where a set Ki of RSs can be received in the resources of an i-th prediction window.

In one example embodiment, the WTRU receives a first set of RS, and determines the predicted CSI. If the WTRU is configured to monitor the current accuracy, the WTRU determines the accuracy of the predicted CSI in a first prediction window, based on the transmitted K1 reference signals (RS) in the first prediction window. When the current accuracy is higher than a configured threshold, the WTRU determines a predicted CSI for a second prediction window (e.g., from measurements performed on the K1 RS and/or previously predicted CSI for the first window).

If the WTRU is configured to monitor the temporal behavior of CSI prediction accuracy, the WTRU determines prediction accuracy in a first prediction window and second prediction window, where the first and second prediction windows are consecutive prediction windows in time. The WTRU determines the preferred number of RS (K3) for validation/tracking in a third prediction window (e.g., occurring after the first and second prediction windows), as a function of prediction accuracy determined in first and second windows, or as a function of the gradient or change of prediction accuracy in the first and second prediction windows. The WTRU reports the measured CSI prediction accuracy of at least one of the first or second prediction windows, and the preferred number of K3 RS for validation/tracking in the third prediction window. Detailed examples of this procedure are discussed further below.

For dynamic reporting of specific predicted CSI components, in one example embodiment, a WTRU performing CSI prediction may be configured to report reduced predicted CSI feedback (e.g. a subset of predicted CSI components). The WTRU is configured with one or more prediction windows (each composed of one or more prediction instances) and one or more sets of reference signals (RSs). The WTRU receives RS(s) from the one or more sets of RSs in a first prediction window to determine one or more predicted CSI components for a second prediction window. Next, the WTRU determines the prediction accuracy of each predicted CSI component, and preferably the rate of change in value of a predicted CSI component (e.g., from two or more instances of a prediction window).

In this example, the WTRU determines a subset of predicted CSI components to include in the reduced predicted CSI feedback report based on the prediction accuracy and/or the rate of change of the predicted component. By way of example, a predicted CSI component may be excluded from the report if its rate of change is below a configured threshold and/or its prediction accuracy is larger than the minimum accuracy. Next, the WTRU reports the subset of predicted CSI components for the second prediction window.

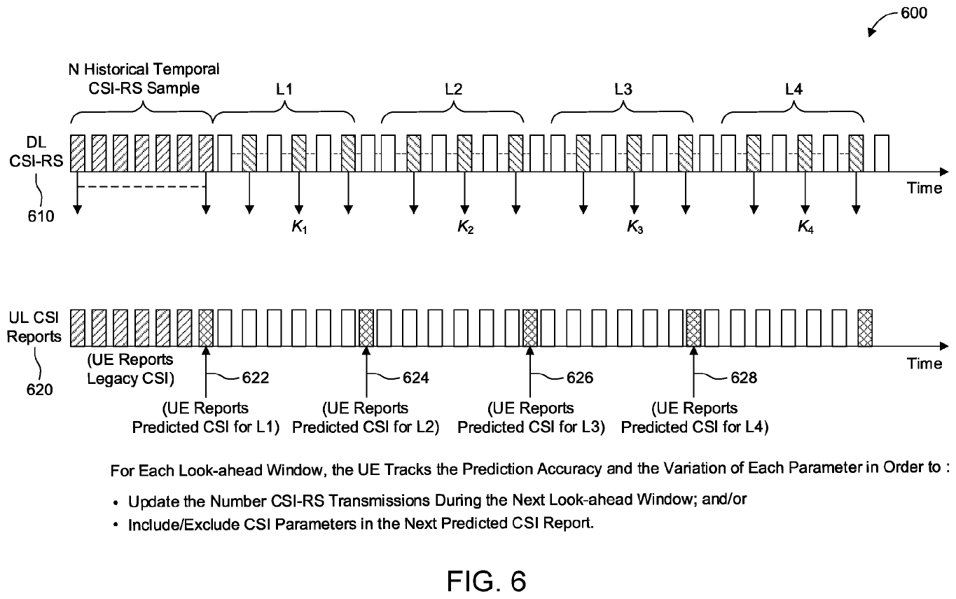

Referring to FIG. 6, a timing diagram 600 for DL RS(s) 610 and WTRU CSI reporting 620 includes aspects related to the various embodiments as shown, in which the following terms are defined as follows:

Look-ahead window: the CSI prediction window, and is typically of size L or Li. As shown in FIG. 6, L1, L2, L3 and L4.

Reference signals: including reference signals used for training an AI/ML for prediction, reference signals used as an input for a CSI predictor to obtain the predicted CSI, and reference signals that are associated with the look-ahead window, and defined as: K or Ki. As shown in FIG. 6, K1, K2, K3 and K4.

Prediction accuracy: is the prediction accuracy of the CSI prediction, which can be measured using prediction accuracy measuring techniques, such as cosine similarity and normalized mean square error (NMSE).

Tracking and checking: is the process of tracking the accuracy of CSI prediction using the reference signals received during a look-ahead window, or a set of look-ahead windows.

Validation: is the process of validating the accuracy of prediction. In this disclosure, this term is used interchangeably with tracking and checking.

Per component accuracy: the prediction accuracy of a single predicted CSI component.

Per component variation: the variation of a single CSI component between consecutive prediction windows.

Various benefits of the proposed CSI prediction accuracy embodiments may include: reduced feedback occasions by reporting the predicted CSI for one or a set of subsequent prediction windows; improved CSI prediction by validating and adjusting the predicted CSI reported in previous windows; joint monitoring of the CSI prediction process by providing the network with the prediction accuracy measured at the WTRU of previously predicted CSI; reducing the number of reference signals, where the WTRU may report a preferred number of RS for validation/tracking in the next look-ahead window; and/or reducing the feedback overhead by excluding a set of CSI components from the predicted CSI report for the next set of subsequent prediction windows, among others.

Detailed examples for CSI prediction are now described. In various example embodiments a WTRU may be configured to perform CSI prediction with or without validation. To perform CSI prediction, a WTRU may be configured with an AI/ML model. In one example a WTRU may be configured to train an AI/ML model to perform CSI prediction.

The WTRU may receive the AI/ML configuration information via semi-static signaling (e.g., radio resource control (RRC)) or through dynamic signaling (e.g., MAC CE or DCI) or some combination of these WTRU configuration methodologies. The WTRU may be activated/deactivated to use CSI prediction in a variety of manners or for a specified period of time. In one example, a WTRU may be configured with CSI prediction with or without validation and may only perform CSI prediction and/or validation upon receiving an activation command.

In certain embodiments, a WTRU may be configured with CSI prediction and reporting, with or without validation, and may also be configured with legacy CSI reporting. In another embodiment, a WTRU may only be expected to report one of CSI prediction or legacy CSI report for a reference resource.

WTRU configuration for CSI prediction. In one example, a WTRU may be configured, with or without validation, to determine one or more of the following factors:
Whether validation is configured.
A configuration for a first set of reference signals (RS). The WTRU may perform measurements on RSs from the first set of RSs to train an AI/ML for prediction. The configuration may include a starting resource (e.g., time) and an end resource (e.g., time) for which the first set of RSs will be transmitted by the network access station, e.g., gNB.
A configuration for a second set of RSs. The WTRU may use measurements performed on the second set of RSs as an input for a CSI predictor (e.g., AI/ML model). For example, the CSI predictor may be used to obtain CSI values for reference resources other than those of the measured RSs. The configuration may include a starting resource (e.g., time) and an end resource (e.g., time) for which the second set of RSs will be transmitted by the gNB.
A first set of CSI reporting resources. The WTRU may report legacy CSI (i.e., CSI related to a reference resource associated with at least one transmitted RS) using at least one resource of a first set of CSI reporting resources. For example, a WTRU may report legacy CSI during AI/ML model training or during accumulation of measurements to be used for CSI prediction.
A second set of CSI reporting resources. The WTRU may report predicted CSI in at least one resource of the second set of CSI reporting resources.
A set of values L=[L1, L2, . . . , Ln]. The WTRU may determine predicted CSI for up to n sets of Lx reference resources. The value x may be considered an index of a look-ahead window. The WTRU may be configured with a second set of CSI reporting resources of size n such that the x-th reporting resource (where 1<=x<=n) is used to transmit CSI values for Lx reference resource. A report for predicted CSI related to a number Lx of reference resources may be of size less than, equal to or greater than Lx.
A set of values K=[K1, K2, . . . , Kn]. The WTRU may be configured with n third sets of RSs. The x-th third set of RSs may be associated with Kx RS resources. The x-th Kx RS resources may be received on resources associated with the Lx reference resources. The WTRU may perform measurements on the x-th third set of RSs to validate CSI predicted for the x-th set of Lx reference resources. The WTRU may determine predicted CSI for the (x+1)-th set of L(x+1) reference resources based on measurements performed on the x-th third set of RSs.
Resources on which the WTRU may request to switch to legacy CSI reporting. The WTRU may assume the first or second set of RSs is transmitted until reception of an indication from the gNB indicating the set is no longer transmitted or active. In one example, the WTRU may indicate to the gNB when it no longer requires RSs from the first or second set of RSs. For example, the WTRU may indicate to the gNB when its CSI predictor AI/ML model has been adequately trained. In another example, the WTRU may indicate to the gNB when it has received enough RSs from the second set to generate a possibly configurable number of predicted CSI with a possibly configurable prediction accuracy

According to various embodiments, the WTRU may be configured with one or more prediction accuracy threshold(s) and may determine that predicted CSI is ready to be reported when it has achieved accuracy greater than or equal to the threshold(s). The WTRU may report the number of predicted CSI values and/or the accuracy of the predicted CSI values.

In certain embodiments, the WTRU determines various CSI prediction parameters. A WTRU may determine that it has obtained a set of predicted CSI that satisfies one or more accuracy criterion, for example, based on measurements performed in a first or second set of RSs as described herein.

In one embodiment, the WTRU may be configured with values L, as described above, and may determine that it has a valid set of predicted CSI when it obtains a set of Lx CSI prediction (or a set of CSI predictions associated with Lx reference resources) that satisfies an accuracy criterion.

In another embodiment, the WTRU may determine values L for which it may obtain sets of predicted CSI that satisfies an accuracy criterion. The WTRU may determine a set of values K that points to the required number of RS resources required for validation of prediction of each set of Lx reference resources.

WTRU reporting of CSI prediction parameters is now described. The WTRU may be configured with resources on which to report the CSI prediction parameters to the gNB and/or the WTRU may request resources to report a new set of CSI prediction parameters. For example, a WTRU may be configured with a resource to request resources to report a new set of CSI prediction parameters. In another example, a WTRU may report a request for resources to report a new set of CSI prediction parameters in a reporting resource of a first set of reporting resources (e.g., used for legacy CSI feedback reporting).

A report of a desired set of CSI prediction parameters may be associated with an indication that AI/ML model training is complete or AI/ML inference is complete. According to various embodiments, the report of CSI prediction parameters may include one or more of the following:
WTRU determined set of values L. The WTRU may also indicate an index or identity of the Lx reference resources (e.g., time stamps) associated with the x-th set of reference resources. The WTRU may also indicate the number of predicted CSI values associated with the x-th set of reference resources. For example, in some cases the WTRU may report a single CSI feedback report value that is applicable to Lx reference resources. In another example, a WTRU may report Lx CSI feedback report values, each associated with one of the Lx reference resources.
WTRU determined set of values K. The WTRU may report a desired or requested distribution of the Kx RS resources associated with the x-th Lx reference resources. For example, the WTRU may request that the Kx RS resources should span the entirety of the Lx reference resources. In another example, the WTRU may request that the Kx RS resources be configured in a burst. The WTRU may explicitly report a desired distribution or report an index of a pre-configured distribution.
Measurement quantities that can be predicted (e.g., RI, CQI, PMI, LI, CRI, SINR, RSRP, RSRQ, RSSI, doppler spread, angle of arrival (AoA), angle of departure (AoD), delay spread, average delay). The WTRU may use a previously configured (e.g., configured by the gNB) set of prediction parameters until it receives acknowledgment that the desired set of prediction parameters is configured.

Predicted CSI feedback reporting. The WTRU may receive configuration information indicating the CSI prediction parameters to use for a subsequent CSI prediction. In one embodiment, the configuration may specify the timing of the look-ahead windows. In another embodiment, the WTRU may report the timing of a look-ahead window (e.g., start time, end time, duration) in a predicted CSI feedback report.

A WTRU may receive an indication activating (or deactivating) one or more third set(s) of RS resources (Kx) and a second set of CSI reporting resources. The WTRU may receive an indication deactivating (or activating) a first or second set of RS resources and a first set of CSI reporting resources.

The WTRU may report a first set of predicted CSI values associated with a first set of reference resources L1. The WTRU may report the first set of predicted CSI values in a reporting resource from the second set of reporting resources. The WTRU may indicate in a feedback report whether it needs to continue reporting legacy feedback for the Lx reference resources, using reporting resources of the first set of reporting resources.

A WTRU may receive an indication from the gNB that reporting resources of the first set of reporting resources are deactivated. A WTRU may be configured with resources to request activation of reporting resources of the first set of reporting resources. In some cases, a resource of a second set of reporting resources may overlap a resource of a first set of reporting resources. In such a case, in certain embodiments, the WTRU may multiplex predicted CSI and legacy CSI in one reporting resource (e.g., of the first or second set of reporting resources). In another embodiment, the WTRU may be configured with a priority instruction and may drop one of the two reports (e.g., the WTRU may drop the legacy CSI feedback report).

In some embodiments, the WTRU may use measurements on a combination of RSs in a first set, or a second set or any i-th third sets (where i<m), that occurs prior to the m-th look-ahead window, to generate predicted CSI related to the Lm reference resources of the m-th look-ahead window. The WTRU may use measurements on a combination of RSs in a first set, or a second set or any i-th third sets (where i<=m) to validate previously reported predicted CSI feedback for the Lm reference resources of the m-th look-ahead window.

WTRU reporting of CSI prediction and CSI prediction validation. According to certain embodiments, a WTRU may report predicted CSI, or predicted CSI validation information, in a reporting format that may include one or more of the following:
A set of predicted CSI values for one or more subsequent look-ahead windows. For example, a WTRU may report predicted CSI values for look-ahead windows 1,2, 3 associated with sets of reference resources L1, L2 and L3.
Validation of previously reported predicted CSI report. For example, a WTRU may report whether the predicted CSI associated with the x-th look-ahead window are valid (e.g., achieve required accuracy) prior to the x-th look-ahead window or following the x-th look-ahead window.
Adjustment to previously reported CSI feedback report. For example, a WTRU may transmit adjustment values for one or more previously reported predicted CSI feedback reports. The adjustment value may be added to the previously reported values or may be entirely new CSI report values.
Request to switch to legacy CSI reporting. For example, if the WTRU determines a predicted CSI does not meet the accuracy requirements or cannot be adjusted to meet the accuracy requirements, the WTRU may request to switch to legacy CSI reporting, i.e., without CSI prediction.
Legacy CSI report. For example, a WTRU may report one or more legacy CSI reports associated with one or more reference resource or RS included in one or more preceding look-ahead windows.

In an embodiment, a WTRU is configured with n look-ahead windows and reports predicted CSI feedback for the x-th look-ahead window prior to (e.g., immediately prior to) the x-th look-ahead window. During the x-th look-ahead window, the WTRU receives Kx reference signals and performs measurements to validate the predicted CSI feedback. The WTRU may report to the gNB the accuracy or validity of predicted CSI for the x-th window following the x-th look-ahead window.

In another embodiment, a WTRU is configured with n look-ahead windows and reports predicted CSI feedback for more than 1 look-ahead windows (e.g., for y look-ahead windows, where y<=n). For example, prior to the y look-ahead windows, the WTRU reports predicted CSI feedback for the y look-ahead windows. During the first window in the set y windows, the WTRU receives Ki RS resources. The WTRU may use measurements on the Ki RS resources to validate the CSI prediction of the first look-ahead window. The WTRU may use measurements on the Ki RS resources to validate or determine adjustments for the other (e.g., subsequent) look-ahead windows in the set y. During the second look ahead-window in the set y windows, the WTRU receives Kj RS resources. The WTRU may use measurements on the Ki or Kj RS resources to validate the CSI prediction of the second window. The WTRU may use measurements on the Ki or Kj RS resources to validate or determine adjustments for the other (e.g., subsequent) look-ahead windows in the set y. This may continue until the last look-ahead window in the set of y windows. The WTRU may report validity or adjustment at the end of any or all look-ahead windows in the set of y windows.

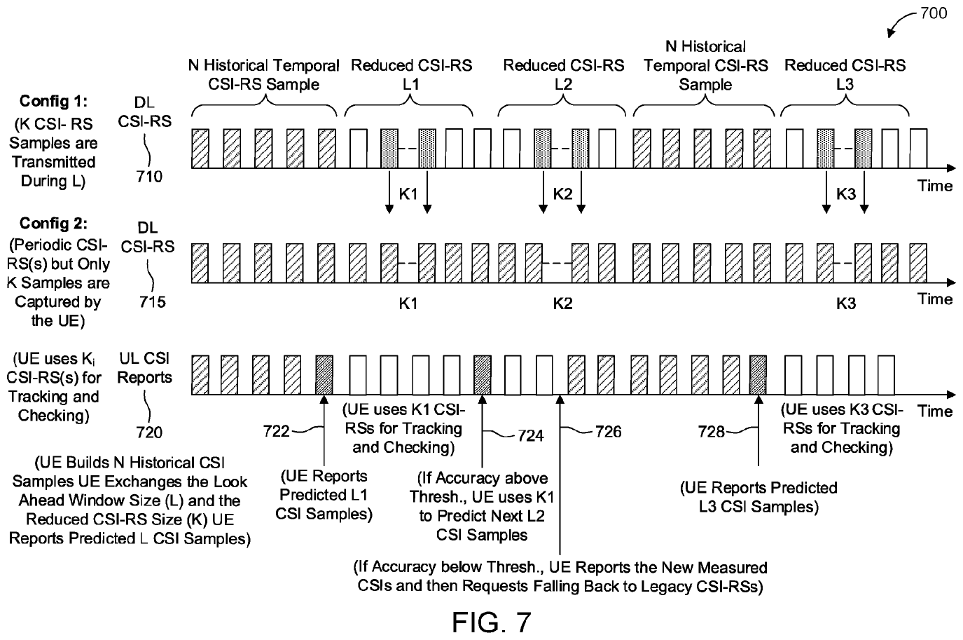

Referring to FIG. 7, timing diagram 700 illustrates an example process of reporting of Lᵢ predicted CSI for the next CSI then receiving Kᵢ CSI-RSs. Diagram 700 shows two example configurations for receiving DL CSI-RS(s), a first configuration 710 in which K CSI-RSs are transmitted by the base station during windows of lengths L1, L2 and/or L3, based on WTRU reporting, and a second configuration 715 for periodic CSI-RSs, in which the number of CSI-RSs transmitted by the base station does not change, but the WTRU may sample/measure less than all CSI-RSs transmitted. The WTRU reports 720 CSI based on received CSI-RS(s) as shown.

In both example configurations 710 and 715 of FIG. 7, the WTRU is configured with two look-ahead windows with L1 and L2 reference resources K1 and K2, respectively. That is, the WTRU is configured with K1 and K2 RS resources in respective look-ahead windows of L1 and L2. Prior to the first look ahead window, the WTRU reports legacy CSI and may receive an additional RS(s) for CSI prediction. Immediately preceding the look-ahead window L1, the WTRU may report 722 predicted CSI for the first look-ahead window L1 based on the RSs received. In this example, during the first look-ahead window L1, the WTRU may perform measurements on the K1 RS resources and immediately preceding the second look-ahead window (with duration L2), the WTRU may determine to report 724 predicted CSI for the second look ahead window. In one example, this reporting may be as a function of the accuracy of the predicted CSI of the first look-ahead window. If and/or when the accuracy of the predicted CSI falls below a configured threshold accuracy, the WTRU may request 726 to switch to legacy CSI reporting. In one example, the WTRU may return to CSI prediction by reporting 728 predicted L3 samples for a next look-ahead window L3.

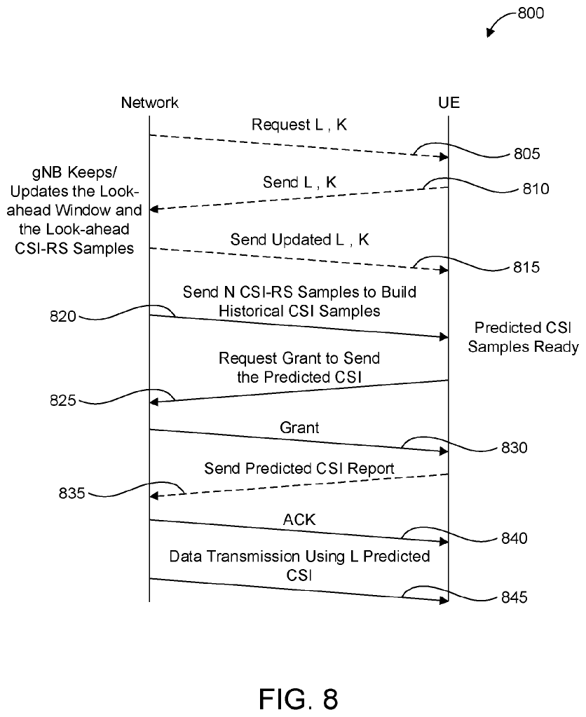

FIG. 8 illustrates an example method 800 of signal/messaging flows between a network and WTRU for the reporting and configuration of CSI prediction parameters, as well as determination of predicted CSI values and reporting of predicted CSI, according to one embodiment. In method 800, optionally, the network may request L (look ahead window length(s)) and K RS resources used by the WTRU for CSI prediction, and the WTRU replies 810 with the requested information. At 815, the network may confirm or alter these parameters and provide 815 indication of the same to the WTRU. Next, the base station sends 820 N number of CSI-RS samples to the WTRU to build a historical CSI sample model for CSI prediction. In this example, the WTRU may request 825 an UL grant, and the base station may provide 830 UL resources, for the WTRU to send 835 a predicted CSI report as described in embodiments herein. The base station may acknowledge 840 the predicted CSI report and transmit 845 data to the WTRU using L (look ahead window duration) and based on the predicted CSI parameters.

In various embodiments, a WTRU performing CSI prediction is configured with CSI prediction parameters. Examples for configuring may include: Look-ahead window length (Li); CSI-RS configuration during the look-ahead window, including the number of CSI-RS (Ki); Accuracy threshold(s) for the predicted CS; Number of consecutive windows to determine behavior of the predicted CSI accuracy; Length of historical CSI samples (N); and/or Grades of accuracy where each accuracy grade translates to a specific number of CSI-RS in the look-ahead window (K).

The WTRU may be configured semi-statically for example via RRC configuration. Some of the parameters (for example the number of CSI-RS in the next look-ahead window) may be changed dynamically, e.g. via dedicated UL and DL signaling.

In one solution, the WTRU receives one or more sets of reference signals, K, where a set Ki can be received in the resources of an i-th prediction window. The WTRU may use the reference signals received during one look-ahead window to determine the accuracy of CSI predicted in a previous window and to determine the preferred number of CSI-RSs for validation and tracking in a third look-ahead window.

WTRU measurements to determine CSI prediction accuracy/behavior of accuracy. During the look-ahead window i of length Lᵢ, the WTRU measures Kᵢ CSI using the Kᵢ received CSI-RSs (0≤Kᵢ≤Lᵢ), where 0 denotes no CSI-RS transmissions and Lᵢ denotes a full CSI-RS transmission during the look-ahead window.

The WTRU may use the reference signals received during the i-th look-ahead window to determine the CSI prediction accuracy α, by computing the relative difference between the measured CSI and the predicted CSI with respect to the Kᵢ received CSI-RS

The WTRU determines and reports the required CSI-RS for the next look-ahead window based on current measured accuracy. In one embodiment, the WTRU compares the current measured CSI prediction accuracy in the look-ahead window i to a configured prediction accuracy threshold to determine the required number of CSI-RS Kᵢ₊₁, in the next look-ahead window i+1.

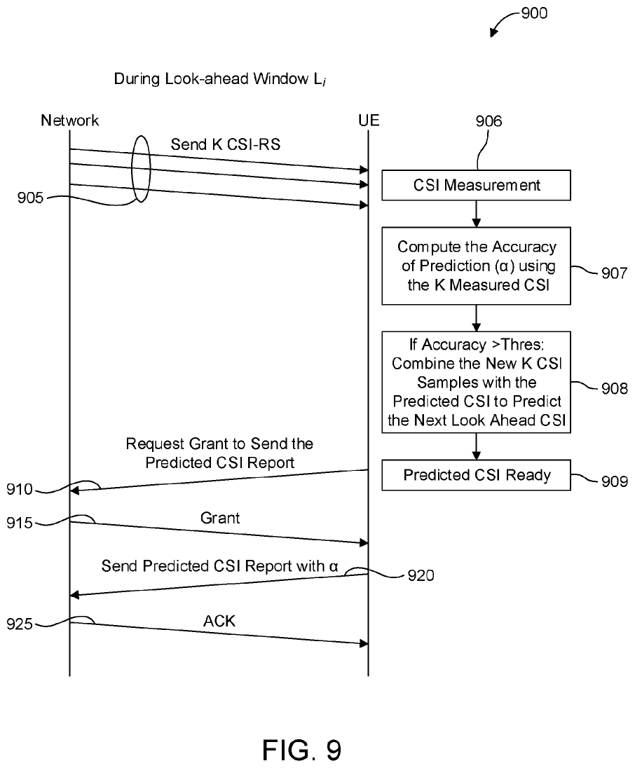

Referring to FIG. 9, an example signal flow diagram 900 is shown when the CSI prediction accuracy is better than a configured threshold, i.e., if α>threshold. As shown in FIG. 9, the WTRU receives 905 Kᵢ CSI-RS during the look-ahead window Lᵢ and measures 906 the corresponding Kᵢ CSI. Next, the WTRU computes 907 the prediction accuracy α using the Kᵢ measured CSI and compares 908 it to the configured prediction accuracy threshold. Subsequently, in one example, the WTRU incorporates both the Kᵢ measured CSI and the Lᵢ predicted CSI to predict the CSI of the next look-ahead window i+1 with length Lᵢ₊₁, which may then be sent 920 to the gNB. As before, the WTRU may request 910 and receive 915 an UL grant prior to sending 920 the predicted CSI report with prediction accuracy α to the base station. In one solution, the value of Kᵢ₊₁ may be computed based on the accuracy level of the previously predicted CSI. Specifically, if the determined accuracy of prediction was high, the number of CSI-RS transmissions may be reduced in the next look-ahead window. If the determined prediction accuracy is low, the WTRU may request, or the base station may determine, an increased number of reference signals should be sent for the next look-ahead window to improve the accuracy of prediction in the next look-ahead window, or set of look-ahead windows. In this example, the base station may acknowledge 925 receipt of the predicted CSI.

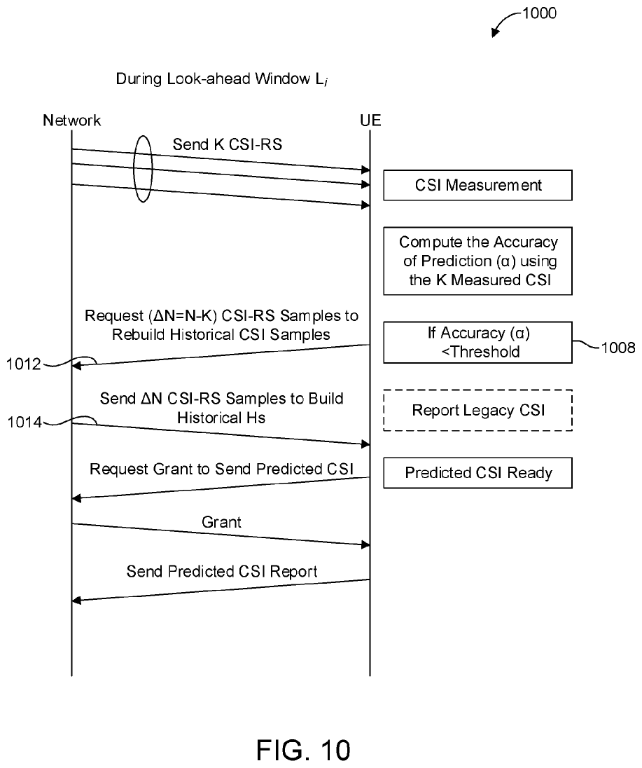

Referring to FIG. 10, an example signal flow diagram 1000 is shown in a similar method as FIG. 9, but when the CSI prediction lower than a configured threshold. Note that similar steps/signaling is not separately described. At step 1008, if α<threshold, the WTRU determines that the prediction accuracy computed using the reference signals received during the i-th look-ahead window is below a specific threshold. In one embodiment of this case, the WTRU may request falling back to legacy CSI reporting to report one or a set of CSI in the i-th window. In another embodiment for this case, the WTRU may report the CSI measured using the reference signals received during the i-th window. Additionally, the WTRU may request 1012 a new set of reference signal (e.g. triggered by DCI or MAC-CE) be sent 1014 by the base station to build a new historical CSI data model to predict the CSI for the next look-ahead window i+1 with length Lᵢ₊₁, or set of look-ahead windows, while reporting legacy CSI until the predicted CSI is accurate enough to be reported. The WTRU may request 1012 ΔN=N−Kᵢ reference signals depending on the distribution of the K references signals in the i-th window. In another example, the WTRU may request N reference signals when the K reference signals received in the i-th are not sufficient to use in the prediction operation. In one option, ΔN may not be limited to N−Ki and ΔN could be determined as a function of related parameters such as N,Ki, α,L,SINR, etc.

In both cases of FIGS. 9 and 10, the WTRU may incorporate the CSI measured through the K CSI-RSs and the CSI prediction accuracy α in the predicted CSI report, which keeps the gNB updated about the accuracy of the prediction process.

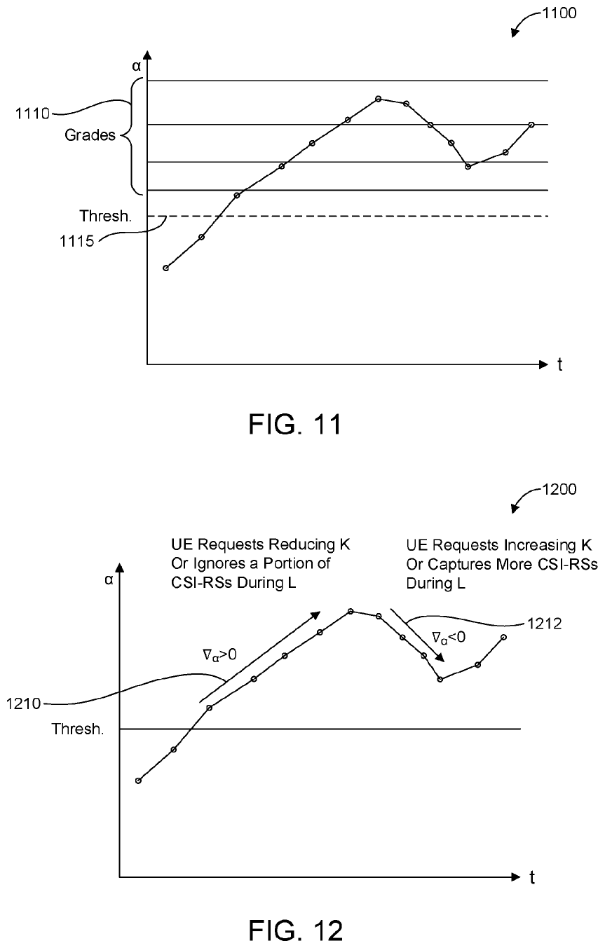

Referring to FIG. 11, a diagram 1100 of graded accuracy levels over time is shown. In some embodiments, the WTRU may define, or have defined by configuration, one or more grades 1110 of prediction accuracy (e.g., varying grades of accuracy that are above the prediction accuracy threshold 1115), where each grade translates to a specific value of K. In certain embodiments, the accuracy grade value can be either reported to the network and the network decides on the number of CSI-RSs or the WTRU maps the accuracy level to specific value of K. The accuracy grade levels may be used for various purposes such as increasing/reducing a number of RSs used for CSI prediction.

In various embodiments, the WTRU determines and reports CSI-RS for the next look-ahead window based on the temporal behavior of prediction accuracy. In certain embodiments, when an accurate prediction is maintained over consecutive windows, for example, two or three windows, the WTRU may request reducing the CSI-RS transmissions in the next window. The number of CSI-RSs during the look-ahead window “i” typically ranges between 0≤Kᵢ≤Lᵢ. Hence, by reducing Kᵢ, the number of CSI-RS transmissions reduces during the look-ahead windows. When the accuracy of prediction reduces over consecutive windows, the WTRU may request an increasing number of CSI-RS transmissions from the base station.

Turning to FIG. 12, a diagram 1200 is shown for monitoring the behavior of prediction accuracy, e.g. using the slope accuracy. In some example embodiments, the WTRU may compute and store the accuracy of CSI prediction to determine the behavior of the accuracy, i.e., whether it is improving or reducing in consecutive windows. For instance, the WTRU may compute the gradient 1210, 1212 of the accuracy between consecutive windows. As shown in FIG. 12, the sign of the gradient 1210, 1212 determines its direction, where a positive gradient 1210 refers to an increasing prediction accuracy, and a negative gradient 1212 indicates a decreasing prediction accuracy. In some examples, the value of the gradient (positive or negative) indicates the steepness of accuracy change (improvement or deterioration) and may be used in predictive CSI operations. For example, in one process, the WTRU may request reducing the value of K in the next window when a positive accuracy gradient 1210 is captured. In contrast, the WTRU may request increasing the value of K in the next window when a negative gradient value 1212 is captured. In both cases, the value of the gradient (positive or negative) may be used to determine the change of K (increase or decrease).

As one example, the gNB may break the current window and request a fall back to legacy CSI reporting to build a new historical N CSI samples to perform prediction for the next look-ahead window. In some embodiments, this may be detected based on some measurements collected, such as detecting a high number of NACKs, or based on the accuracy level reported by the WTRU.

Embodiments for dynamic reporting of specific predicted CSI components will now be described.

Dynamic CSI Control Using per Component Accuracy. In one example embodiment, the WTRU may be configured, indicated, or requested to indicate, per CSI component accuracy of a specific CSI component or set of CSI components as well as the number of CSI-RS required for the next look-ahead window. In one example, the WTRU receives Ki CSI-RSs during the i-th look-ahead window and performs measurements on the CSI-RSs to assess the accuracy of prediction for each CSI component in the reported CSI report (i−1) window (e.g. CQI, RI, PMI) for per CSI component validation. In some embodiments, the WTRU may compute the prediction accuracy of at least one of the following CSI components:

Overall accuracy (the whole CSI report): a; or accuracy of components: CQI: α_{CQI}; RI: α_{RI}; PMI: α_{PMI}; CRI: α_{CRI}; LI: α_{LI}; L1-RSRP: α_{L1RSRP}; Coherence bandwidth: α_{CB}; Coherence time: α_{CT}; Doppler spread: α_{D}_{_{f}}; and/or SSBRI: α_{SSBRI}.

Additionally, in some embodiments, the WTRU may break down CSI components that have multiple parameters to track the prediction accuracy of each parameter in the corresponding CSI component, given that some parameters vary more frequently than other parameters in one CSI quantity. For example, the PMI includes multiple components (e.g., W₁, W₂), hence it may be further broken down to accuracy of W₁: α_{W}_{₁}; W₂: α_{W}_{₂}; W_{f}: α_{W}_{_{f}}; and/or W_{d}: α_{w}_{_{d}}.

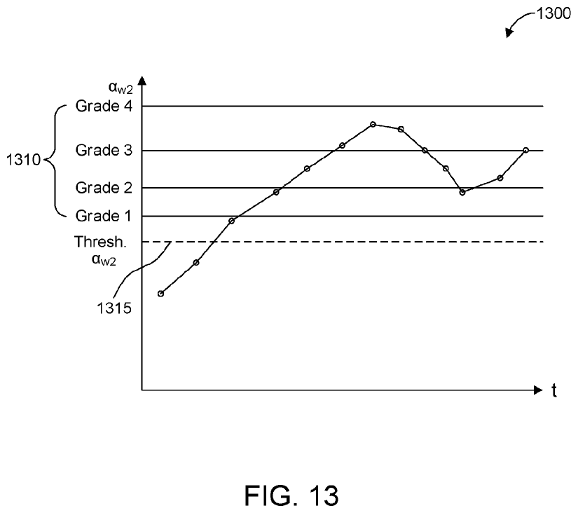

According to further embodiments, the WTRU may report the prediction accuracy of each CSI component or the “grade” of accuracy for each CSI component, or set of CSI components, based on a predefined accuracy grading system. The WTRU may assess the grade of accuracy based on prediction accuracy of each CSI component, and instead of reporting the accuracy, the accuracy grade may be reported. An example of a grading system for the accuracy of W₂ is shown in FIG. 13 diagram 1300. As shown, the prediction accuracy of W₂ is measured on a scale of four grades 1310, all of which are above the predefined minimum accuracy threshold 1315. In this case, each grade may correspond to a specific value of K, and as the accuracy grade improves—hence the accuracy, the value of K may be decreased.

In certain embodiments, a WTRU may report one or more of:
The predicted CSI for the next look-ahead window or the next set of look-ahead windows.
List of prediction accuracies for a set of CSI components in the predicted CSI report for the target look-ahead window. For example, a WTRU may report whether the predicted CSI component or set of CSI components in the i-th look-ahead window attains a specific criterion (e.g., above a specific threshold). The list of prediction accuracy in certain embodiments may be one or more of: Prediction accuracy for a set of CSI components or all CSI components in the predicted CSI report; information about the per component accuracy levels measured (e.g. maximum, minimum, mean etc.); and/or grade of accuracy for a set of CSI components or all CSI components in the predicted CSI report.
Adjustments to previously reported CSI components (e.g., based on the CSI components prediction accuracy). For instance, the WTRU may transmit modified values for one or more previously reported CSI components.
Adjustment to the set of K values with their distribution for the corresponding look-ahead window.
Request to switch to legacy CSI reporting. For example, if the WTRU determines a predicted CSI does not meet the accuracy requirements or cannot be adjusted to meet the accuracy requirements, the WTRU may request to switch to legacy CSI reporting.
A request to fall back to legacy CSI reporting. For instance, when the WTRU performs measurements on at least one CSI component it may request falling back to legacy in case, either the measured per component prediction accuracy doesn't attain a specific criterion (e.g., prediction accuracy threshold) or a CSI component, or set of CSI components, are adjusted, but still do not attain a specific level of accuracy.
Legacy CSI report. For example, a WTRU may report one or more legacy CSI reports associated with one or more reference resource or RS included in one or more preceding look-ahead windows.

The network may use the reported per-component accuracies and/or the preferable value of K to increase or reduce the number of CSI-RS transmissions during the look-ahead window. The network may also use the recommended number of CSI-RS transmissions reported by the WTRU. In one embodiment, the number of CSI-RS transmissions utilized in the next look-ahead window may be equivalent to the number of CSI-RS transmissions required for a CSI component with the lowest prediction accuracy.

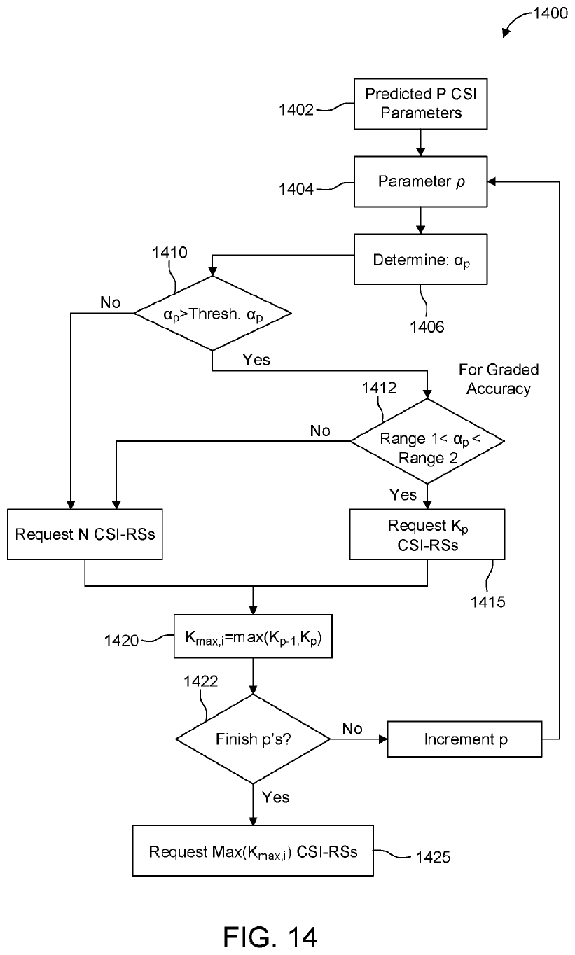

Referring to FIG. 14, a method 1400 for determining the number of CSI-RS transmission during the next look-ahead window based on the per component accuracy is shown. In this embodiment of a process of determining the number K is shown where the WTRU iterates through P CSI components 1402 to determine K 1420, and for each CSI component p, 1404 Kₚ CSI-RSs 1415 are required. After evaluating all available CSI components 1422, K may be determined 1425 equal to the maximum value from the following Equation 3:

$${K}_{p} ( e . g . max \{ {K}_{p} \} ∀ p in P ) \qquad Eq . 3$$

In this effort, the WTRU may be configured by the network (e.g. through DCI) to track the per component accuracy during the i-th look-ahead window, or a set of look-ahead windows. The WTRU may be requested to compute the accuracy for all CSI components or a specific set of CSI components. Additionally, in certain embodiments, the WTRU may be configured to report the selected per component accuracy values based on two options: (i) report the per component prediction accuracy for each CSI-RS received prior to the next look-ahead window; and/or (ii) report the per component prediction accuracy measured using all Ki reference signals after the current look-ahead window.

Relying on the K CSI-RSs transmitted during the look-ahead window, the WTRU computes the CSI samples and obtains the accuracy 1406, 1410, 1412 for each CSI component p. The WTRU may utilize the computations to determine/adjust the suitable number K of reference signals for the next look-ahead window.

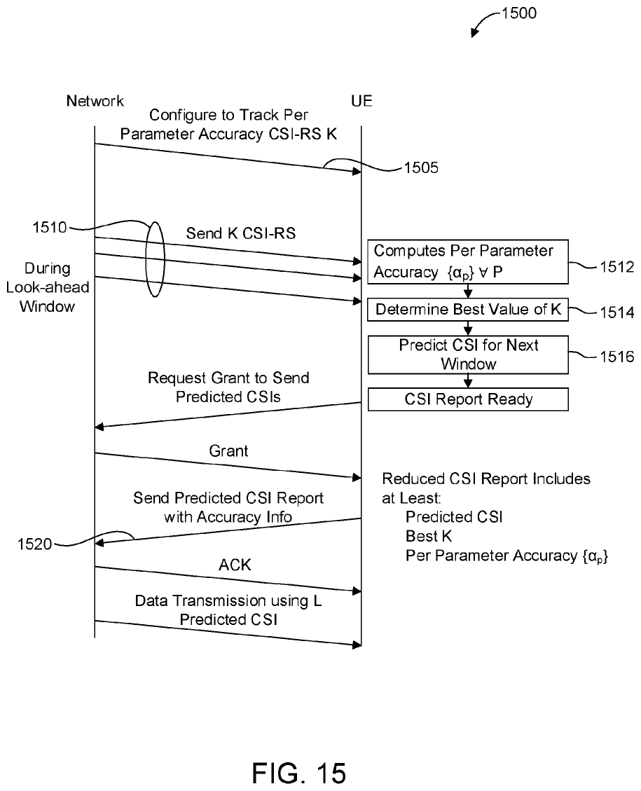

Referring to FIG. 15, an example method 1500 for signaling/messaging flow of per component accuracy reporting is shown. In one example embodiment, the WTRU may be configured 1505, indicated, or requested, to dynamically report specific CSI components and indicate the number of CSI-RS required for the next look-ahead window. Upon receiving K CSI-RS(s) sent 1510 from the base station, the WTRU may compute 1512 accuracy αₚ for configured CSI parameters p and determine 1514 a best value K for CSI-RS(s) in future windows based on the determined accuracies αₚ. determine 1516 predicted CSI for a next window or set of windows. The WTRU may send 1520 the predicted CSI report similarly to other embodiments.

In certain embodiments, the WTRU may be configured to send 1520 a reduced CSI report including predicted CSI, the best K and per parameter accuracies αₚ. In one example, the WTRU may choose a set of CSI components based on variation of CSI components (e.g., per component variation) and/or the per-component accuracy. In one example, the WTRU receives Ki reference signals during the i-th look-ahead window and performs measurements to assess the variation of each CSI component, or a selection of CSI components, as well as the per-component prediction accuracy. Based on the variation requirements (e.g., variation within a specific range), the WTRU may exclude a specific CSI component, or set of CSI components, from the next CSI report, given that its accuracy level is above a specific threshold.

Tracking the per component variation. In some embodiments, the WTRU may take additional measurements of the CSI components, such as the per component variation (tracking the change of each CSI component) between two or more consecutive windows. If there were frequent changes in the measured CSI components, the WTRU may include them in the next CSI report. However, when a CSI component, or a set of CSI components, remain relatively stable (based on a specific threshold/range) over a specific set of windows, the WTRU may omit these CSI components in the next CSI report.

In one embodiment, the WTRU may track the change of at least one CSI component over a specific number of look-ahead windows, by comparing the value of in the previous interval to the current predicted value. This can be achieved by obtaining at least one variation of accuracy Δ, where Δₚ denotes the change of CSI component p between the currently predicted window and the previous window. Examples of potential variations may include one or more of: Overall accuracy: Δ or changes in CQI: Δ_{CQI}; RI: Δ_{RI}; PMI: Δ_{PMI}; CRI: Δ_{CRI}; LI: Δ_{LI}; L1-RSRP: Δ_{L1RSRP}; Coherence bandwidth: Δ_{CB}; Coherence time: Δ_{CT}; Doppler spread: Δ_{D}_{_{f}}; and/or SSBRI: Δ_{SSBRI}.

Additionally, in certain embodiments, the WTRU may break down CSI quantities that have multiple CSI components to track the per component variation. For instance, the PMI may be further broken down to changes in W₁: Δ_{W}_{₁}; W₂: Δ_{W}_{₂}; W_{f}: Δ_{W}_{_{f}}; and/or W_{d}: Δ_{W}_{_{d}}

The CSI component variation Δₚ may be a number that indicates the amount of change of a specific CSI component between two windows. The value of Δ may be obtained based on the type of CSI component as follows:

When a CSI component p is defined as an integer, such as RI, then Δₚ can be defined as αₚ=p_{L}_{ᵢ}−p_{L-1}, where i denotes the index of the window. When the CSI component p is defined as a vector or a matrix, such as W₁, Δₚ may be obtained using the norm operation, e.g., Δₚ=∥p_{L}_{ᵢ}−p_{L}_{_{i−1}}∥.

According to certain embodiments, the WTRU may be configured to track the amount of change of at least one CSI component over a specific number of windows I, where if Δₚ remains below a specific threshold (e.g. |Δₚ|<Thresh.) or falls within a specific range (e.g. Thresh. 2<|Δp|<Thresh. 1) the WTRU may exclude the CSI component from the next CSI report.

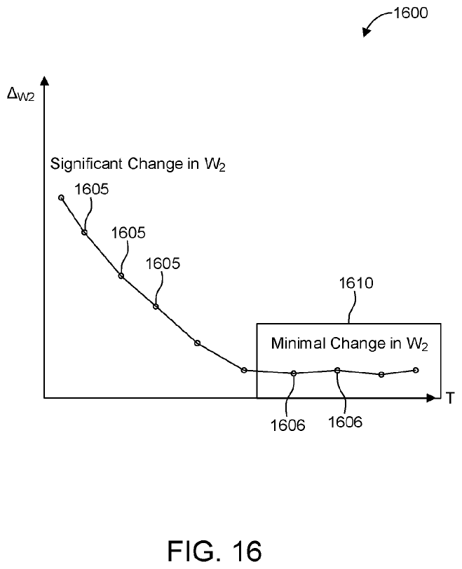

FIG. 16 is a timing diagram 1600 showing an example embodiment of the variation of Δ_{W}_{₂} over multiple windows 1605. It can be seen in FIG. 16, that the variation of W₂ is relatively stable in the highlighted box 1610, which indicates that the W₂ has not changed significantly in the last few windows 1606.

In another embodiment, the WTRU may categorize CSI components into a group of components that are mutually dependent, such that if one CSI component in the group is included in the CSI report, all other components in the group should also be included.

By way of example, if the precoding matrix W₂ has undergone significant changes (e.g., |Δ_{W}_{₂}|>Thresh.) over the current and previous I−1 windows, the precoding matrix W₂ will be included in the next CSI report. When considering that both W₂ and W_{f} are necessary to capture the precoder vectors for the full set of full FD units, they may be grouped together. On the other hand, W₁ is independent of W₂ and typically experiences less frequent changes, thus W₁ can be placed in a separate group and will not need to be included in the CSI feedback message if it has not undergone any changes in the past I windows.

In implementation of the disclosed embodiments, the WTRU may be configured to report a reduced CSI report based on a specific set of conditions such as the regularity of change of a specific CSI component, or set of components, over a specific set of windows. Upon obtaining the reduced CSI report request (where at least one CSI component is excluded from a requested CSI report), the WTRU reports to the network indicating that a reduced CSI report is available and the WTRU may not include in the CSI report the set of components that have remained relatively stable (e.g. Δₚ<Thresh.) over a specific number of windows. In various embodiments, the WTRU then reports the reduced CSI report corresponding to the predicted look-ahead window using, for example, via the PUSCH.

Dynamic Reporting and CSI-RS Control Based on joint per-component accuracy and per-component variations. In one example embodiment, the WTRU may be configured to dynamically report the predicted CSI and recommend the number of CSI-RS transmission to utilize during one or more look-ahead windows. Additionally, the WTRU may be allocated resources on which the WTRU may request/fall back to legacy CSI reporting to report CSI components with accuracy levels below a specific threshold. In this example, the WTRU monitors the per-component accuracy and the per-component change to further reduce the CSI overhead.

The configuration for reduced CSI prediction, with or without validation, may include a configuration for reporting a reduced CSI report after obtaining the predicted CSI for a window L. The WTRU may report the reduced predicted CSI in at least one resource. The WTRU may conduct measurements on a set of RSs in order to validate the CSI that has been predicted for the set of Li reference resources. Additionally, the WTRU may perform measurements to obtain one or both the prediction accuracy of each CSI component and the variation of each CSI component. The WTRU may determine predicted CSI for the (i+1)-th set of L(i+1) reference resources based on measurements performed on a set of RSs during the window Li. Then the WTRU uses the measurements of the per component accuracy and per component variation to include/exclude CSI components in the L(i+1) window.

Alternatively, or in addition, the configuration for reduced CSI prediction, with or without validation, may include resources that the WTRU may request to fall back to legacy CSI reporting. This may be invoked when the prediction accuracy of at least one element is obtained.

During the look-ahead window Li, the WTRU receives Ki reference signals and performs measurements on each CSI component to validate the predicted CSI feedback and obtain per-component accuracy and the per-component variation. In certain embodiments, the WTRU may also report validation results to the gNB.

In one example embodiment, the WTRU may report to the gNB the per-component accuracy and the per-component variation of predicted CSI for the i-th window. Additionally, the WTRU may use measurements on the Ki RS resources to determine adjustments for the at least one CSI component for the subsequent look-ahead windows. The WTRU may adjust and report the number of reference signals K to utilize for the next look-ahead window. For example, based on the determined per-component accuracy and per-component variation, the WTRU may adjust the number K of reference signals that may be required for the next look-ahead window.

In some embodiments, the WTRU may exclude a set of the predicted CSI components from the predicted CSI. For example, after obtaining the predicted CSI for the next look-ahead window, the WTRU may exclude a set of CSI components if it determines that the variation of these components meet a specific requirement (e.g., the variation of a CSI component is below a specific threshold), given that the prediction accuracy of excluded CSI components meets a specific threshold (e.g., prediction accuracy of the CSI components is below a specific threshold).

In certain embodiments, the WTRU may request falling back to legacy CSI reporting when it determines that the prediction accuracy of a specific CSI component or set of components for predictive CSI, falls below, or does not meet the accuracy requirement. In one example, a WTRU may report a request for resources to report a new set of CSI components in a reporting resource for the components that did not meet an accuracy requirement (e.g., did not meet or exceed a prediction accuracy threshold).

According to various embodiments, a WTRU may report at least one of:
The predicted CSI for the next look-ahead window or the next set of look-ahead windows;
A reduced CSI report for the next look-ahead window or the next set of look-ahead windows (for example, the WTRU may exclude a CSI component that meets the accuracy requirement and variation requirement);
List of prediction accuracies for a set of CSI components in the predicted CSI report for the target look-ahead window;
Adjustments to previously reported CSI components (e.g., based on the CSI components prediction accuracy);
Adjustment to the number of reference signals K with their distribution for the target look-ahead windows;
Request to switch to legacy CSI reporting; and/or
Legacy CSI report (for example, if the WTRU determines a predicted CSI component does not meet the accuracy requirements or cannot be adjusted to meet the accuracy requirements, the WTRU may request to switch to legacy CSI reporting to report at least the set of components that did not meet the accuracy requirements).

Example Embodiments of Joint Variation And Accuracy Processing. In one example, the WTRU may perform measurements on the Ki reference signals received in the i-th look-ahead window. The measurements may include determination of the per component prediction accuracy and the per component variation.

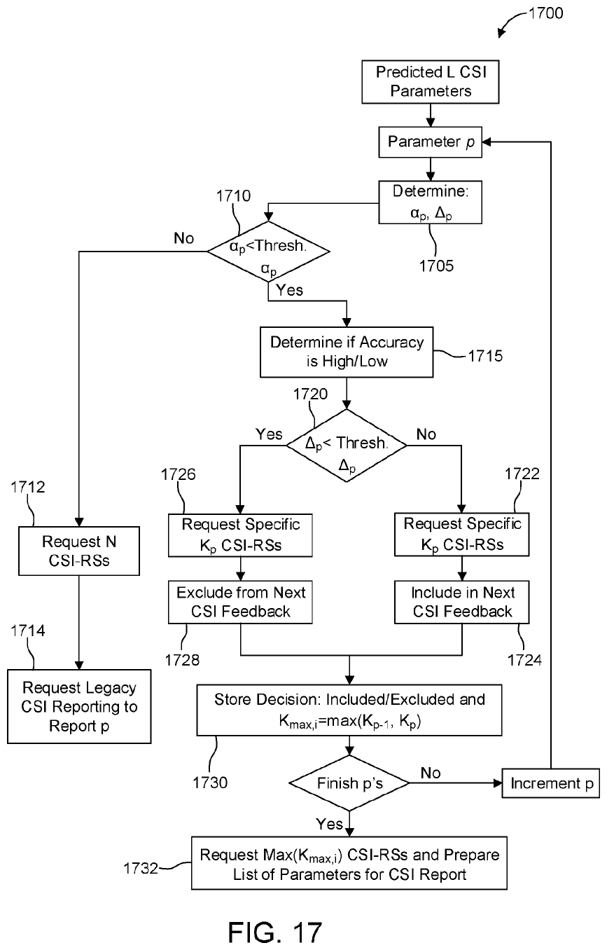

Referring to FIG. 17, an example method 1700 of the WTRU including/excluding a CSI component p in the CSI report is shown. In this example, an accuracy requirement may be defined including multiple accuracy thresholds. In one embodiment, three thresholds may be defined including a basic accuracy threshold (αₚ), a high accuracy threshold (e.g., a specific range or level of accuracy above the basic accuracy) and a low accuracy threshold (e.g., a specific range of accuracy above the basic accuracy but below the high accuracy threshold). In one embodiment, a variation requirement is also defined (e.g., variation threshold Δp).

Once these thresholds are defined, method 1700 may include the following steps:

The WTRU initializes K=Ki and defines list S={ }, which contains all CSI components that will be excluded from the CSI report. Next, the WTRU determines 1705 an accuracy and change of each given CSI parameter p in P CSI components as αₚ, Δₚ.

For (each p in P CSI components):
If 1710 the accuracy of p is below a specific threshold (e.g., αₚ<Thresh.), then the WTRU requests 1712 falling back to legacy to report 1714 p and determines a new set n of reference signals to predict p for the next look-ahead window; else
If 1710 accuracy of p is above a specific threshold, (e.g., αₚ>Thresh.), then the WTRU determines 1715 whether the accuracy of is a high accuracy or a low accuracy:
   If the accuracy level is low (e.g., R1_{1ow}<αₚ<R2_{low}), the WTRU sets a higher number of Kp reference signals for a next look-ahead window; or
   If the accuracy level is high (e.g., R1_{high}<αₚ<R2_{high}), the WTRU sets a lower number of Kp reference signals for a next look-ahead window.
Next, the WTRU determines If 1720 the variation Δ of the CSI parameter p meets the variation threshold thresh Δp:
   If 1720 the variation requirement is unsatisfied (e.g., Δₚ>thresh Δₚ.), the WTRU may request 1722 specific RSs for Kp (e.g., to continue receiving and/or increase RSs) and include 1724 related information in the CSI report for the next look-ahead window; or
   If 1720 the variation requirement is satisfied (e.g., Δₚ<thresh Δₚ.), the WTRU may add parameter p to list S (CSI components that will be excluded 1728 from the CSI report). In this case the WTRU may also request 1726 specific RSs for Kp (e.g., to cancel or reduce the number of RSs relating to parameter p).

The WTRU repeats this process for all parameters p for P CSI components to determine 1730 the maximum number of K, Ki=max (Kₚ∀p in P) and then exclude all CSI components p in S. Lastly, the WTRU requests 1732 the maximum (K_{imax,i}) CSI-RSs and prepares a list of parameters for the CSI report.

An analogy result of the foregoing process is summarized in Table 2 below:

TABLE 2
Procedure for WTRU to determine which
components to include/exclude.

αₚ

| | Low accuracy of | High accuracy of |
|---|---|---|
| Δₚ | predicted component | predicted component |
| Low | Request (larger) Kₚ | Request (smaller) Kᵢ |
| | CSI-RSs | CSI-RSs |
| | Include component p in | Exclude p in next |
| | next CSI prediction | predicted CSI report |
| High | Request (larger) Kᵢ | Request (smaller) Kᵢ |
| | CSI-RSs | CSI-RSs |
| | Include component p in | Predict p and include in |
| | next CSI prediction | next CSI prediction |

Common CSI Prediction Components. In the previously described embodiments, processes and features relate to a WTRU configured by the gNB to perform adaptive CSI prediction with selected components and dynamic reporting one or more of the following, or any combination of:
One or more sets of reference signals for training, prediction, monitoring the performance (accuracy), and validation of the models;
WTRU-based adaptation of the reference signals in one or any combination of density and pattern in time, frequency, and spatial domains, and for particular time windows (e.g., X time units);
One or a set of CSI prediction windows, all or any combination of CSI components for prediction, one or set of prediction accuracy threshold, type of accuracy monitored;
One or more sets of radio resources for CSI prediction reporting based on all or any combination of CSI components;
One or more sets of radio resources for WTRU-based adaptive reference signal (e.g., CSI-RS) indication.
Embodiments for a WTRU to perform adaptive CSI prediction and performance monitoring (accuracy) with respect to the configured selected CSI components and selected windows (including length L), using the received set or sets of reference signals, and the processing may include one or more of the following or any combination of:
WTRU determining the predicted CSI for all or any combination of CSI components for selected windows;
WTRU computing the accuracy of CSI prediction for all or selected CSI components for a next look-ahead window, or several windows;
WTRU selection of the preferred CSI component or components for a next look-ahead window, or several windows;
WTRU selection of the preferred accuracy threshold for gNB configured or preferred CSI components;
WTRU selection of the preferred (adaptive) reference signal configuration for particular time windows (e.g., X time units);
In all WTRU processing embodiments herein, the WTRU may utilize the predictions from previous measurements in conjunction with the received set, or sets, of reference signals for performing adaptive CSI prediction and performance monitoring.

The WTRU utilizes dynamic reporting related to adaptive CSI prediction with selected components, using previously configured one or more sets of radio resources reserved, which may include one or a combination of the following procedures:
WTRU reporting the predicted CSI (all or any combination of CSI components) for the selected time window, or multiple windows;
WTRU reporting the preferred CSI component subset for future CSI prediction in subsequent time windows;
WTRU reporting the preferred prediction accuracy thresholds based on the initial gNB configured or WTRU selected preferred configuration for CSI components;
WTRU reporting the preferred reference signal configuration, including any pattern and density in time, frequency, and spatial domain, for CSI prediction in components for next look-ahead window, or several windows;
WTRU reporting any adjustment or validation for the previously predicted CSI report, or multiple reports.

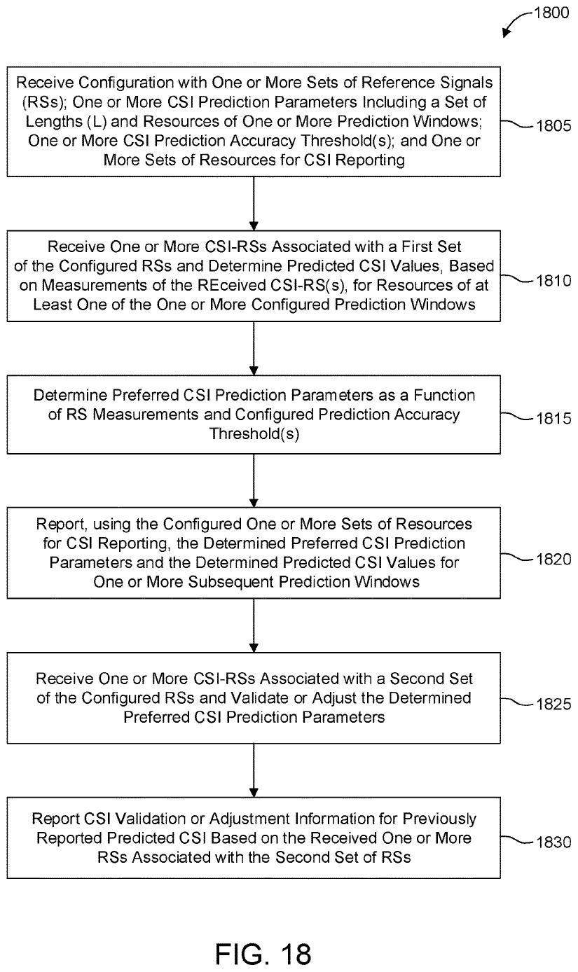

Referring to FIG. 18, a method 1800 for CSI prediction according to one example embodiment is shown. The method generally includes configuring 1805 a WTRU with one or more sets of reference signals (RSs); one or more CSI prediction parameters including a set of lengths (L) and resources of one or more prediction windows; one or more CSI prediction accuracy threshold(s); and one or more sets of resources for CSI reporting. In various embodiments, one set of configured reference signals (RS) may be used for legacy CSI measurement and AI/ML model training. Another set of configured RS(s) may be used for CSI prediction in a subsequent prediction window (e.g., look ahead), and yet a further set of RS(s) may be used for validating or adjusting previously predicted CSI.

Next, the WTRU receives 1810 CSI-RSs associated with a set of configured RSs and, based on their measurements, determines predicted CSI values for resources of at least one of the configured prediction windows. As in other example embodiments described herein, although CSI-RSs may be shown or described, other types of reference signals or combinations of RS types may be utilized and the embodiments are not limited to any particular type of RS(s). The WTRU further may determine 1815 preferred CSI prediction parameters as a function of RS measurements and configured prediction accuracy threshold(s) according to any one or combination of the embodiments previously discussed. In some embodiments, preferred CSI prediction parameters may include prediction window lengths (L) and/or a number of RS resources for validation of predicted CSI in a subsequent look-ahead windows.

Using the configured one or more sets of resources, the WTRU may report 1820 the determined preferred CSI prediction parameters and predicted CSI values for one or more subsequent prediction windows.

In some optional embodiments, method 1800 may continue with the WTRU receiving 1825 additional CSI-RSs associated with the RS configuration sets and the WTRU may use corresponding measurements to validate or adjust the determined preferred CSI prediction parameters of a prediction window. Lastly, the WTRU may report 1830 validation or adjustment information for previously reported predicted CSI based on the received additional CSI-RSs.

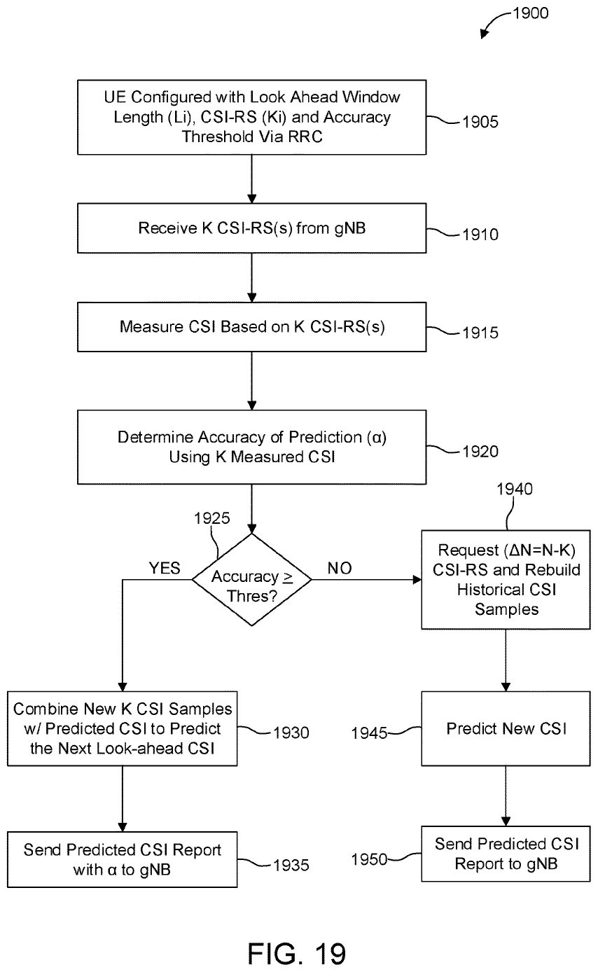

Turning to FIG. 19, an example method 1900 of WTRU providing CSI prediction information to a base station is shown. A WTRU is configured 1905 with look ahead window length(s) (Li), CSI-RS(s) (Ki), one or more accuracy thresholds, and CSI reporting resources via RRC. The WTRU receives 1910 K number of CSI-RS(s) from the base station measures 1915 CSI based on the received CSI-RS(s) and determines 1920 an accuracy (a) of prediction for CSI components and/or component parameters. If 1925 the determined accuracy is greater than the related configured threshold, the WTRU combines new K CSI samples with existing CSI prediction information, if any, predicts CSI for a next look-ahead window (L) and reports 1935 the predicted CSI, and optionally the determined accuracy (a) to the base station. If 1925, on the other hand, the determined accuracy is less than the related configured threshold, the WTRU may request 1940 additional CSI-RSs to rebuild historical CSI samples and/or falls back to legacy CSI reporting. The WTRU may use the received CSI-RS(s) to predict 1945 CSI for a next look-ahead window (L) and report 1950 the predicted CSI to the base station.

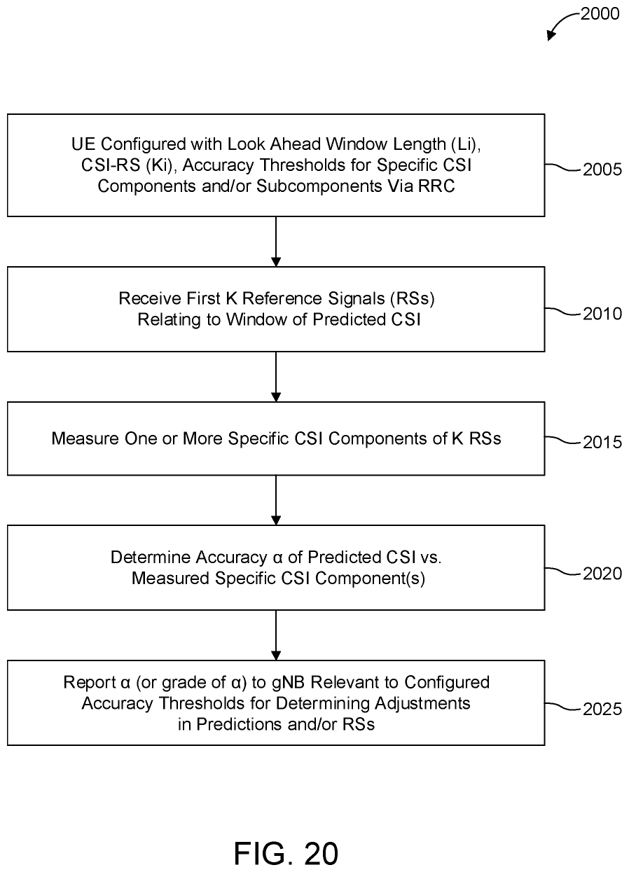

Referring to FIG. 20, a method 2000 for dynamic reporting of specific predicted CSI Components according to one example embodiment is shown. In this method 2000, a WTRU using AI/ML modeling for predictive CSI, may be configured 2005, indicated, or requested to indicate, per CSI component accuracy thresholds for a specific CSI component, subcomponent or set of CSI components, a number of CSI-RS required for the next look-ahead window and CSI reporting resources. The WTRU receives 2010 Ki CSI-RSs during an i-th look-ahead window and performs 2015 measurements to determine 2020 the accuracy of prediction a for each specific CSI (sub)component in a previous predicted CSI report (i−1) window (e.g. α_{CQI}, α_{RI}, α_{PMI}) for per CSI component validation. Additionally, or in the alternative, an accuracy of a specific parameter (or subcomponent) of a specific CSI component (e.g., PMI subcomponents W₁, W₂, W_{f}, W_{d}→α_{W1}, α_{W2}, α_{Wf}, α_{Wd}) may be determined and used in predicting CSI, validating CSI predictions, and/or modifying selection of reference signals for CSI measurements. Optionally, any of the aforementioned specific CSI component or subcomponent accuracies α may be assessed “grades” for CSI prediction purposes as similarly discussed previously. The WTRU may report 2025 the accuracy or accuracies α, or a grade(s) of a, for validating predicted CSI, determining adjustments in predictions and/or revising a number of K CSI-RSs to receive in one or more next look-ahead window (i+1 . . . i+2, etc.).

In one solution, the WTRU receives Ki CSI-RSs during the i-th look-ahead window and performs measurements to assess the accuracy of prediction for each CSI component in the reported CSI report (i−1) window (e.g. CQI, RI, PMI) for per CSI component validation. The WTRU may compute, and optionally report, a list of prediction accuracies for a set of CSI components in the predicted CSI report for the target look-ahead window. A further reduced set of RSs K may be requested and sampled/measured by the WTRU for validating future look-ahead windows when K meets one or more accuracy thresholds. The predictive CSI parameter L and K as well as, at least CSI measurements for K are provided to the gNB.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless transmit receive unit (WTRU), the method comprising:
receiving, from a base station, configuration information including: a first set of reference signals (RSs) for channel state information (CSI) prediction; one or more CSI prediction parameters including a set of lengths (L) and resources of one or more prediction windows; one or more prediction accuracy thresholds; and one or more sets of resources for CSI reporting;
receiving, from the base station, one or more RSs associated with the configured first set of RSs and determining predicted CSI values for resources of at least one of the one or more configured prediction windows;
determining preferred CSI prediction parameters as a function of RS measurements and configured prediction accuracy threshold(s); and
reporting, to the base station, using the configured one or more sets of resources, the determined preferred CSI prediction parameters and the determined predicted CSI values for one or more subsequent prediction windows.

2. The method of claim 1, wherein the configuration information further includes a second set of RSs to validate predicted CSI, and the method further comprises:
receiving, from the base station, one or more RSs associated with the configured second set of RSs and validating or adjusting the determined preferred CSI prediction parameters; and
reporting, to the base station, CSI validation or adjustment information based on the received one or more RSs associated with the second set of RSs.

3. The method of claim 2, wherein the determined preferred CSI prediction parameters are validated when measurements of the one or more RSs associated with the configured second set of RS meet or exceed an accuracy criterion.

4. The method of claim 3, further comprising:
requesting a reduced number of RSs for the one or more subsequent prediction windows when the accuracy criterion is exceeded by a predetermined amount; or
requesting an increased number of RSs for the one or more subsequent prediction windows when the accuracy criterion is exceeded by less than the predetermined amount.

5. The method of claim 1, wherein the determined predicted CSI values relate to one or more of rank indicator (RI), channel quality index (CQI), precoding matrix indicator (PMI), layer indicator (LI), CSI-RS resource indicator (CRI), signal interference-to-noise ratio (SINR), reference signal received power (RSRP), reference signal received quality (RSRQ), received signal strength indicator (RSSI), doppler spread, angle of arrival (AoA), angle of departure (AoD), delay spread or average delay.

6. The method of claim 1, wherein the determined preferred CSI prediction parameters comprises one or more of a length of a prediction window or a number of RS resources desired for a prediction window.

7. The method of claim 1, wherein the configuration information includes a third set of RSs and the method further comprises:
prior to receiving the one or more RSs associated with the configured first set of RSs, receiving, from the base station, one or more RSs associated with the configured third set of RSs; and
training an artificial intelligence machine learning (AIML) model for CSI prediction based on the received RS(s) associated with the configured third set of RSs while the WTRU performs legacy CSI reporting.

8. A wireless transmit receive unit (WTRU) comprising:
a processor and a transceiver in communication with the processor, the processor and transceiver configured to:
receive, from a base station, configuration information including: a first set of reference signals (RSs) for channel state information (CSI) prediction; one or more CSI prediction parameters including a set of lengths (L) and resources of one or more prediction windows; one or more prediction accuracy thresholds; and one or more sets of resources for CSI reporting;
receive, from the base station, one or more RSs associated with the configured first set of RSs and determining predicted CSI values for resources of at least one of the one or more configured prediction windows;
determine preferred CSI prediction parameters as a function of measurements of the received one or more RSs and configured prediction accuracy threshold(s); and
report, to the base station, using the configured one or more sets of resources, the determined preferred CSI prediction parameters and the determined predicted CSI values for one or more subsequent prediction windows.

9. The WTRU of claim 8, wherein the configuration information further includes a second set of RSs to validate predicted CSI, and the processor and transceiver are further configured to:
receive, from the base station, one or more RSs associated with the configured second set of RSs and validating or adjusting the determined preferred CSI prediction parameters; and
report, to the base station, CSI validation or adjustment information based on the received one or more RSs associated with the configured second set of RSs.

10. The WTRU of claim 9, wherein the determined preferred CSI prediction parameters are validated when measurements of the one or more RSs associated with the configured second set of RS meet or exceed an accuracy criterion.

11. The WTRU of claim 10, wherein the processor and transceiver are further configured to:
request a reduced number of RSs for the one or more subsequent prediction windows when the accuracy criterion is exceeded by a predetermined amount; or
request an increased number of RSs for the one or more subsequent prediction windows when the accuracy criterion is exceeded by less than the predetermined amount.

12. The WTRU of claim 8, wherein the determined predicted CSI values relate to one or more of rank indicator (RI), channel quality index (CQI), precoding matrix indicator (PMI), layer indicator (LI), CSI-RS resource indicator (CRI), signal interference-to-noise ratio (SINR), reference signal received power (RSRP), reference signal received quality (RSRQ), received signal strength indicator (RSSI), doppler spread, angle of arrival (AoA), angle of departure (AoD), delay spread or average delay.

13. The WTRU of claim 8, wherein the determined preferred CSI prediction parameters comprise one or more of a length of a prediction window or a number of RS resources desired for a prediction window.

14. The WTRU of claim 8, wherein the configuration information includes a third set of RSs and the processor and transceiver are further configured to:
prior to receiving the one or more RSs associated with the configured first set of RSs, receive, from the base station, one or more RSs associated with the configured third set of RSs; and
train an artificial intelligence machine learning (AIML) model for CSI prediction based on the received RS(s) associated with the configured third set of RSs while the WTRU performs CSI reporting without prediction.

15. A method for a base station, the method comprising:
sending, to a wireless transmit receive unit (WTRU), configuration information including: a first set of reference signals (RSs) for channel state information (CSI) prediction; one or more CSI prediction parameters including a set of lengths (L) and resources of one or more prediction windows; one or more prediction accuracy thresholds; and one or more sets of resources for CSI reporting;
sending, to the WTRU, one or more RSs associated with the configured first set of RSs for the WTRU to determine predicted CSI values for resources of at least one of the one or more configured prediction windows; and
receiving, from the WTRU, via the configured one or more sets of resources, predicted CSI values and preferred CSI prediction parameters for one or more subsequent prediction windows.

16. The method of claim 15, wherein the configuration information further includes a second set of RSs to validate predicted CSI, and the method further comprises:
sending, to the WTRU, one or more RSs associated with the configured second set of RSs to enable the WTRU to validate or adjust the preferred CSI prediction parameters; and
receiving, from the WTRU, CSI validation or adjustment information based on the received one or more RSs associated with the configured second set of RSs.

17. The method of claim 16, wherein the preferred CSI prediction parameters are validated when measurements of the one or more RSs associated with the configured second set of RS meet or exceed the configured one or more prediction accuracy thresholds.

18. The method of claim 17, further comprising:
receiving a request for a reduced number of RSs for the one or more subsequent prediction windows when the configured one or more prediction accuracy thresholds is exceeded by a predetermined amount; or
receiving a request for an increased number of RSs for the one or more subsequent prediction windows when the configured one or more prediction accuracy thresholds is exceeded by less than the predetermined amount.

19. The method of claim 15, wherein the received predicted CSI values relate to one or more of rank indicator (RI), channel quality index (CQI), precoding matrix indicator (PMI), layer indicator (LI), CSI-RS resource indicator (CRI), signal interference-to-noise ratio (SINR), reference signal received power (RSRP), reference signal received quality (RSRQ), received signal strength indicator (RSSI), doppler spread, angle of arrival (AoA), angle of departure (AoD), delay spread or average delay.

20. The method of claim 15, wherein the received preferred CSI prediction parameters comprise one or more of a length of a prediction window or a number of RS resources desired for a prediction window.
